(19) United States
(12) Patent Application Publication
(10) Pub. No.: US 2026/0138890 A1
(43) Pub. Date: May 21, 2026

(54) WATER FILTER AND HOME APPLIANCE HAVING SAME

(71) Applicant: LG ELECTRONICS INC., Seoul (KR)

(72) Inventors: Jongpil KIM, Seoul (KR); Seonghee LIM, Seoul (KR)

(21) Appl. No.: 19/349,365

(22) Filed: Oct. 3, 2025

(30) Foreign Application Priority Data
Nov. 15, 2024 (KR) 10-2024-0163471

(51) Int. Cl. C02F 1/00; F25D 23/00

(52) U.S. Cl. CPC C02F 1/003; F25D 23/00; C02F 2201/004; C02F 2307/12; F25D 2323/121

(57) ABSTRACT

The present disclosure relates to water filter and a home appliance having the water filter, the water filter detachably coupled to a head connected to a water supply source comprising: a housing having an upper opening opened upward and coupled to the head by rotation; a filter cover provided inside the housing, configured to cover the upper opening, and including a water inlet part for water inflow and a water outlet part for water outflow; and a filter member connected to the filter cover inside the housing for water purification, wherein a restricting protrusion protrudes from an inner surface of the housing, a restricting groove into which the restricting protrusion is inserted is formed along a circumference of the filter cover, the housing is rotated relative to the stationary filter cover, and a rotation angle of the housing is restricted by the restricting protrusion and the restricting groove.

### CROSS-REFERENCE TO RELATED APPLICATIONS

The present application claims the benefits of priority to Korean Patent Application No. 10-2024-0163471, filed on November 15, 2024, of which its incorporated herein by reference in its entirety.

### THE BACKGROUND

The present disclosure relates to water filter and a home appliance having the same.

Generally, the filter device may include a head provided on a flow path through which water flows, and a filter detachably coupled to the head and having a built-in filter member for purification. According to the type of the filter member, the filter device may have various purification performances, and the filter device may be configured by a coupling of a plurality of filters having different types of filter members.

In addition, these filter devices require periodic replacement to maintain water purification performance, and can be configured to have an easy-to-replace structure so that the user can easily replace them at any time desired.

Meanwhile, the filter device may have a structure that is convenient for mounting and separation, and in particular, various structures are being developed in which incorrect mounting is prevented and accurate mounting is induced by the coupled structure of the head and the filter.

In addition, a filter device is being developed that switches the internal flow path of the head by rotating the filter during the process of attaching and detaching the filter to the head, thereby preventing water leakage even when the filter is separated.

However, in such filter devices, there is a problem that the internal flow path structure of the head for switching the flow path is complicated. In addition, if the flow path is switched repeatedly, the durability of the head is reduced, and this causes a problem of water leakage.

### THE SUMMARY

An object of an embodiment of the present disclosure is to provide a water filter and a home appliance having the water filter, which are capable of preventing leakage.

An object of an embodiment of the present disclosure is to provide a water filter and a home appliance having the water filter, which are capable of visualizing the alignment state of the water inlet part and the water outlet portion of the filter cover relative to the housing during relative rotation.

An object of an embodiment of the present disclosure is to provide a water filter and a home appliance having the water filter, which are capable of ensuring accurate installation of the water filter.

As an embodiment of the present disclosure, a water filter may detachably couple to a head connected to a water supply source comprises the water filter detachably coupled to a head connected to a water supply source comprising: a housing having an upper opening opened upward and coupled to the head by rotation; a filter cover provided inside the housing, configured to cover the upper opening, and including a water inlet part for water inflow and a water outlet part for water outflow; and a filter member connected to the filter cover inside the housing for water purification, wherein a restricting protrusion protrudes from an inner surface of the housing, a restricting groove into which the restricting protrusion is inserted is formed along a circumference of the filter cover, the housing is rotated relative to the stationary filter cover, and a rotation angle of the housing is restricted by the restricting protrusion and the restricting groove.

The housing may include a protrusion protruding toward a center of the housing to form the upper opening, and a circumference of the filter cover is restrained from upward movement by the protrusion.

The restricting protrusion may protrude downward from a lower portion of the protrusion.

The water filter may further comprises a sealing member that seals between the protrusion and the filter cover, wherein the restricting protrusion may provided below the sealing member.

The protrusion may comprises: a first protrusion protruding toward the center of the housing and forming the upper opening; and a second protrusion formed in a stepped below the first protrusion and located farther away from the center of the housing than the first protrusion, wherein the restricting protrusion protrudes downward from the second protrusion.

The filter cover may be inserted and mounted through an opened lower surface of the housing, a support protrusion protruding inward may be formed on an inner surface of the housing to support a lower end of the filter cover, and a rim groove recessed upward may be formed along the circumference of the filter cover so that the support protrusion passes therethrough.

The restricting protrusion may be positioned above the support protrusion, and when the support protrusion may passe through the rim groove, the restricting protrusion may be inserted into the restricting groove.

The support protrusions may be disposed on left and right sides with respect to a center of the housing, and the restricting protrusion may be formed at a position rotated by a first set angle with respect to an extension line (LH) passing through the support protrusions and the center of the housing.

Both ends of the restricting groove may be formed at positions rotated by a third set angle with respect to a vertical extension line (LV) passing through the center of the filter cover and the rim groove, and the first set angle and the third set angle may be identical.

Both ends of the restricting groove may be spaced apart by an angle of 90° with respect to the center of the filter cover, and the restricting protrusion may come into contact with each end of the restricting groove at a start and an end of the rotation of the housing.

The filter cover may comprise: a cover upper surface exposed through the upper opening, on which the water inlet part and the water outlet part are formed; a cover rim extending downward along a circumference of the cover upper surface; and a stepped portion formed along the cover rim with a larger diameter than the cover upper surface, wherein the restricting groove may be formed in the stepped portion.

A plurality of contact protrusions protruding upward may be formed on an upper surface of the cover rim and configured to contact a circumferential surface of the upper opening.

As another embodiment of the present disclosure, a water filter may detachably couple to a head connected to a water supply source comprising: a housing having an upper opening formed to be opened upward and coupled to the head by rotation; a filter cover provided in the housing to cover the upper opening and configured to rotate relative to the housing; a water inlet part protruding upward from the filter cover; a water outlet part protruding upward from the filter cover; and a filter member disposed inside the housing and connected to the filter cover for purifying water, wherein an alignment portion for indicating a rotational alignment state of the filter cover may be formed outside the upper opening.

The water inlet part and the water outlet part may be disposed on opposite sides with respect to a center of the filter cover, when the filter cover may be in a normal alignment state, the alignment portion may be located on the same extension line as the water inlet part and the water outlet part, and

When the filter cover may be not in the normal alignment state, the alignment portion may be not located on the same extension line as the water inlet part and the water outlet part.

The housing may have a protruding portion protruding toward a center of the housing to form the upper opening, and wherein the alignment portion may be formed on the protruding portion.

The housing may include an upper part forming an upper end of the housing and extending to be inserted into the head, and wherein the alignment portion may be formed on an inner surface of the upper part.

The water inlet part and the water outlet part may be positioned on opposite sides with respect to a center of the filter cover, wherein the alignment portion may be formed on both sides of the water inlet part and the water outlet part, respectively, and when the filter cover may be in the normal alignment state, the water inlet part and the water outlet part may be aligned between the pair of alignment portions.

Guide protrusions protruding for rotational coupling of the housing may be formed on both outer sides of the housing, and when the filter cover may be in the normal alignment state, the alignment portion, the water inlet part, and the water outlet part may be positioned on the same extension line as the guide protrusions.

As another embodiment of the present disclosure, a home appliance comprising: a cabinet; a head provided in the cabinet and connected to a water supply source; and a water filter detachably coupled to the head, wherein the water filter may comprise: a housing having an upper opening formed to be opened upward and coupled to the head by rotation; a filter cover provided inside the housing to cover the upper opening and including a water inlet part through which water is introduced and a water outlet part through which water is discharged; and a filter member disposed inside the housing and connected to the filter cover for purifying water, wherein a restricting protrusion may protrude from an inner surface of the housing, wherein a restricting groove into which the restricting protrusion is inserted may be formed along a circumference of the filter cover, wherein the housing may be rotated relative to the filter cover, and wherein a rotation angle of the housing may be restricted by the restricting protrusion and the restricting groove.

The water inlet part and the water outlet part may be formed to have an elliptical cross-section when viewed from above, and are oriented and aligned in predetermined directions.

### BRIEF DESCRIPTION OF THE DRAWINGS

FIG. 1 is a view illustrating a flow path structure for water supply of a refrigerator according to a first embodiment of the present disclosure.

FIG. 2 is an exploded perspective view showing the filter of the filter assembly separated from the head according to a first embodiment of the present disclosure.

FIG. 3 is an exploded perspective view of the head.

FIG. 4 is a cross-sectional view taken along line 4-4 of FIG. 2.

FIG. 5 is an exploded perspective view of a valve, which is a component of the head.

FIG. 6 is a bottom view of the head.

FIG. 7 is an exploded perspective view of the filter.

FIG. 8 is a side view of the upper portion of the filter as seen from one side.

FIG. 9 is a side view of the upper portion of the filter as seen from the opposite side.

FIG. 10 is a perspective view of the upper housing of the filter as seen from above.

FIG. 11 is a top plan view of the upper housing.

FIG. 12 is a bottom view of the upper housing.

FIG. 13 is a sectional perspective view taken along line 13-13 of FIG. 7.

FIG. 14 is a perspective view of the filter cover of the filter as seen from above.

FIG. 15 is a top plan view of the filter cover.

FIG. 16 is a perspective view of the filter cover as seen from below.

FIG. 17 is a longitudinal sectional view showing a state in which the upper housing and the filter cover are assembled.

FIG. 18 is a top plan view of the filter showing a rotational state of the housing.

FIG. 19 (a) and (b) is a view illustrating the state of the fixing protrusion and the fixing groove according to rotation of the housing.

FIG. 20 is a top plan view of the filter before the filter is mounted.

FIG. 21 is a longitudinal sectional view showing a state in which the filter and the head are separated before assembly.

FIG. 22 is a view illustrating a coupling structure of the guide protrusion and the guide part when the filter is coupled to the head.

FIG. 23 is a cross-sectional view taken along line 23-23 of FIG. 22.

FIG. 24 is a top plan view of the filter while being inserted into the head.

FIG. 25 is a longitudinal sectional view showing the coupling state of the filter and the head as shown in FIG. 24.

FIG. 26 is a front view showing a state in which the filter and the head are completely coupled.

FIG. 27 is a top plan view of the filter when the filter and the head are completely coupled.

FIG. 28 is a longitudinal sectional view showing the coupling state of the filter and the head as shown in FIG. 27.

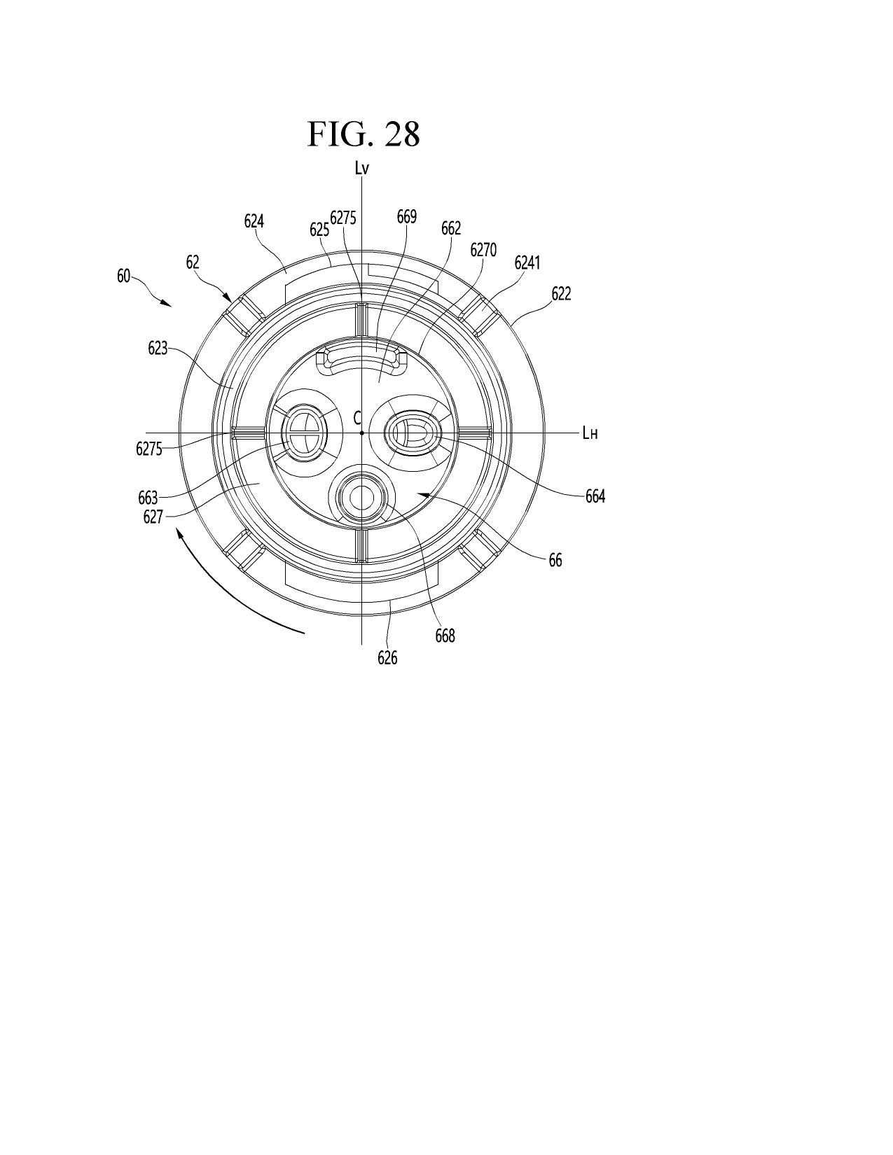

FIG. 29 is a view illustrating water flow when the filter is completely coupled to the head.

FIG. 30 is a longitudinal sectional view showing a coupling state of the housing and the filter cover according to the second embodiment of the present disclosure.

FIG. 31 is a partial perspective view of the filter as seen from above according to the third embodiment of the present disclosure.

### DETAILED DESCRIPTION

Hereinafter, specific embodiments of the present disclosure will be described in detail with reference to the drawings. However, the present disclosure is not limited to the embodiments in which the idea of the present disclosure is presented, and other regressive disclosures or other embodiments included within the scope of the idea of the present disclosure can be easily proposed by adding, changing, deleting, or the like other components.

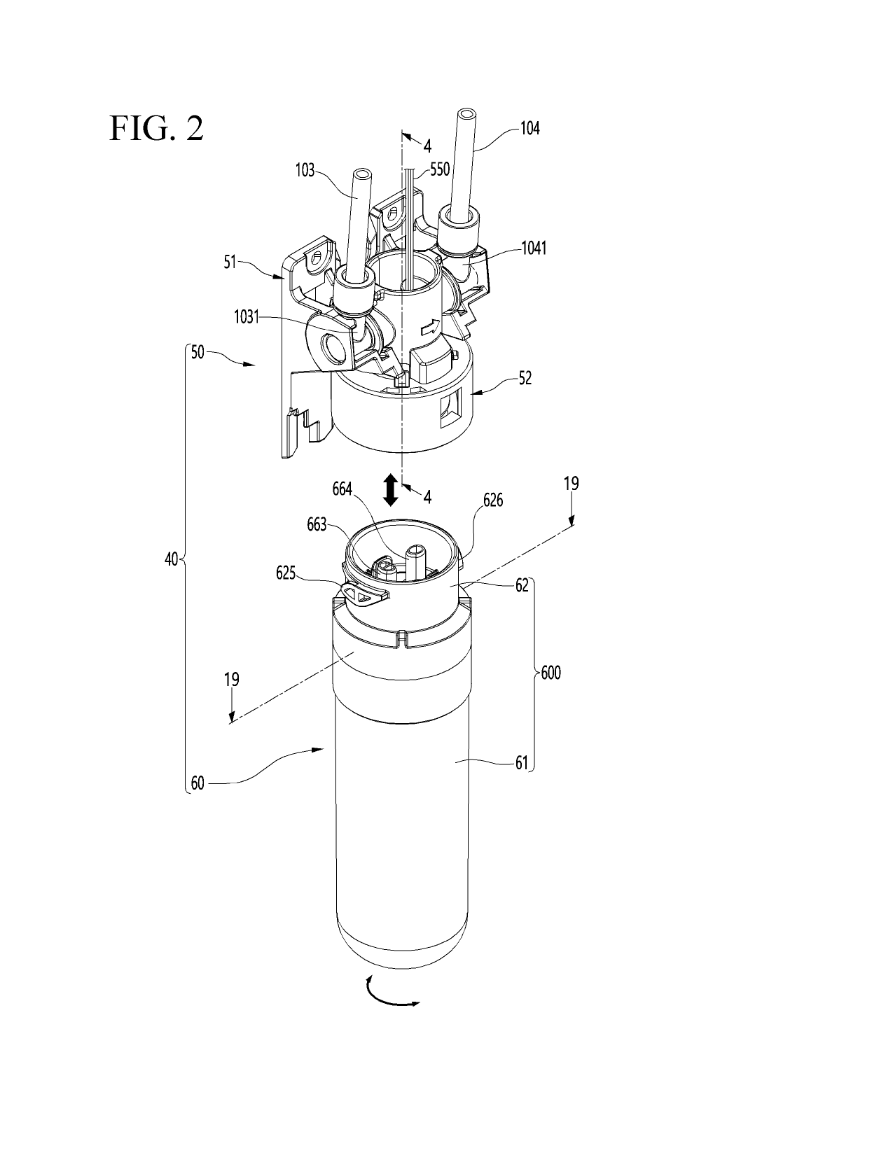

Before the explanation, the direction is defined. In the embodiment of the present disclosure, the direction toward the head in FIG. 2 may be referred to as an upper direction, the direction toward the filter may be referred to as a lower direction, the direction toward the mounting member may be referred to as a rear direction, and the direction away from the mounting member may be referred to as a front direction. In addition, the direction toward the center of the filter and the head may be referred to as an inner direction, and the direction away from the center may be referred to as an outer direction.

In addition, although the embodiment of the present disclosure has been described using a refrigerator as an example among many home appliances, it should be noted in advance that the filter according to the embodiment of the present disclosure can be applied to various home appliances requiring purified water, such as water purifiers and ice makers, without being limited in structure and shape.

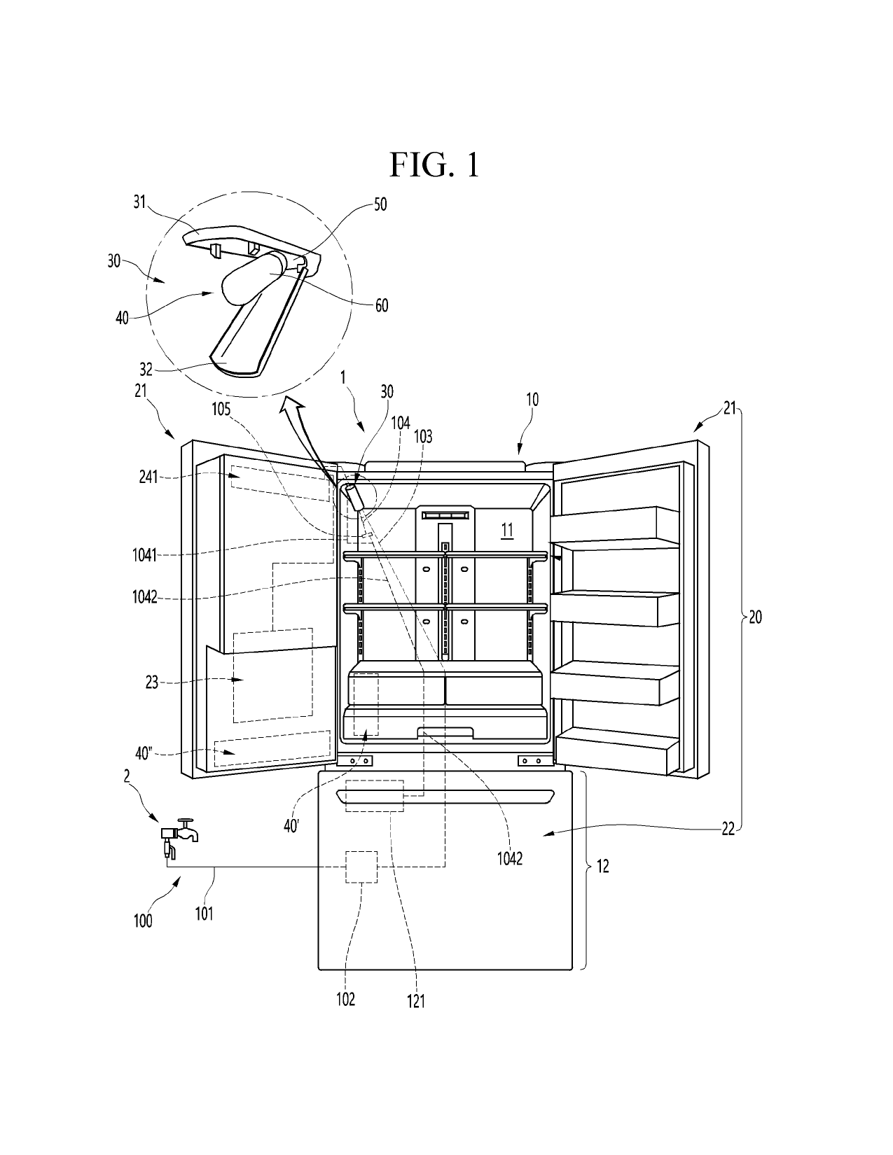

FIG. 1 is a view illustrating a flow path structure for water supply of a refrigerator according to a first embodiment of the present disclosure.

As illustrated, a refrigerator 1 according to an embodiment of the present disclosure may have an outer appearance formed by a cabinet 10 forming a storage space and a door 20 for opening and closing the storage space of the cabinet 10.

The storage space may include a refrigerating compartment 11 positioned at the upper part of the cabinet 10 and a freezing compartment 12 positioned at the lower part of the cabinet 10.

The door 20 may include a refrigerating compartment door 21 and a freezing chamber door 22 that independently open and close the refrigerating compartment 12 and freezing compartment 13, respectively. The refrigerating compartment doors 21 may be provided in pairs on the left and right sides, and may be configured to open and close the refrigerating compartment 11 by rotation. In addition, the freezing chamber door 22 may have a structure like a drawer and may be configured to open and close the freezing compartment 12 by being pulled in and out.

According to the disposition of the storage space and the type and shape of the refrigerator that opens and closes the storage space, an embodiment of the present disclosure may have various structures, and for convenience of explanation and understanding, the embodiment of the present disclosure will be described based on a refrigerator in which the refrigerating compartment is disposed above the freezing compartment and is opened and closed by a pair of doors.

A dispenser 23 and an ice maker 241 may be provided on one of the pair of refrigerating compartment doors 21. The ice maker 241 may be provided inside the refrigerating compartment 11 or in the freezing compartment 12 rather than on the refrigerator door.

The dispenser 23 is provided on the front surface of the refrigerating compartment door 21 and can be configured to allow a user to operate it from the outside to dispense water or ice. In addition, an ice making compartment 24 is provided above the dispenser 23. The ice making compartment 24 is an insulated space where ice is made and stored, and the ice maker 241 is accommodated inside thereof and can be configured to be opened and closed by a separate door.

In addition, an ice maker 121 may be provided inside the freezing compartment 12. the ice maker 241 provided in the refrigerating compartment 11 may be referred to as a first ice maker 241, and the ice maker 121 provided in the freezing compartment 12 may be referred to as a second ice maker 121.

The refrigerator 1 may be equipped with a filter assembly 40 for purifying water supplied from an external water supply source 2. For example, the water supply source 2 may be a tap water source. In addition, the water supply source 2 may be a container storing water, such as a water tank. the water tank may be provided inside or outside of the refrigerator 1.

The filter assembly 40 can be connected to a water device that uses purified water. The water device can include an ice maker that makes ice, a dispenser that dispenses purified water, or the like. In addition, the water device and filter assembly 40 can be used in other home appliances such as a water purifier rather than a refrigerator.

For example, water supplied from the water supply source 2 may be purified by the filter assembly 40 and then dispensed to the dispenser 23 or supplied to the ice maker 241, 121. In addition, the water supply source 2, the filter assembly 40, the dispenser 23, and the ice maker 241, 121 may be connected by a water supply flow path 100.

In detail, the water supply flow path 100 may include a connection pipe 101 connected to the water supply source 2 and a water supply valve 102 inside the cabinet 10. The water supply flow path 100 may include a water inlet pipe 103 and a water outlet pipe 104. The water inlet pipe 103 may be configured to connect the water supply valve 102 and the filter assembly 40 to supply water to the filter assembly 40. The water outlet pipe 104 may be connected to the filter assembly 40 and the dispenser 23 or the ice maker 241, 121 to supply purified water.

In addition, the water outlet pipe 104 may be branched by a branch valve 105. For example, the water outlet pipe 104 may include a first water outlet pipe 1041 that supplies purified water to the dispenser 23 and the first ice maker 141, and a second water outlet pipe 1042 that supplies purified water to the second ice maker 121.

the filter assembly 40 may be provided in the refrigerating compartment 11. For example, the filter assembly 40 may be provided at a corner of one of the left and right sides of the upper surface of the refrigerating compartment 11. As another example, the filter assembly 40' may be provided between storage members such as drawers or shelves of the refrigerating compartment 11 or at a rear part covered by the storage members. As another example, the filter assembly 40'' may be provided in the refrigerating compartment door 21.

Meanwhile, the filter assembly 40 may be configured to facilitate replacement of the filter 60, in which actual water purification is performed. As one example, a filter device 30 may be provided in the refrigerator compartment 11. The filter device 30 may include a case 31 mounted to the cabinet 10, a cover 32 configured to open and close the case 31, and the filter assembly 40 installed inside the case 31 so as to be exposed when the cover 32 is opened.

The filter assembly 40 may include a filter 60 and a head 50. When the cover 32 is opened, the filter 60 may be exposed forward, allowing easy attachment and detachment. The filter 60 is for water purification and may be referred to as a water filter or simply a filter.

Below, the structure of the filter assembly 40 is described in more detail with reference to the drawings.

FIG. 2 is an exploded perspective view showing the filter of the filter assembly separated from the head according to a first embodiment of the present disclosure.

As illustrated, the filter assembly 40 may include a head 50 for mounting the filter assembly 40 and a filter 60 detachably mounted on the head 50.

For example, the head 50 may include a mounting member 51 and a head body 52. The mounting member 51 is for mounting the filter assembly 40, and a fixing member such as a screw may be fastened to fix the filter assembly 40 to a target location. For example, the mounting member 51 may be fixed to one side of the refrigerating compartment 11. Meanwhile, when a structure for mounting the head 50 is provided in the refrigerator 1, the mounting member 51 may be omitted.

The head body 52 can be rotated with respect to the mounting member 51 while the filter 60 is mounted, thereby making it easier to attach or detach the filter 60.

The water inlet pipe 103 and the water outlet pipe 104 may be connected to both sides of the head body 52. The water inlet pipe 103 and the water outlet pipe 104 may be connected to the head body 52 by a water inlet pipe fitting 1031 and a water outlet pipe fitting 1041, respectively. Accordingly, water flowing in through the water inlet pipe fitting 1031 from the water inlet pipe 103 may pass through the head body 52 and be supplied to the filter 60, and water purified in the filter 60 may pass through the head body 52 and be discharged to the water outlet pipe 104 through the water outlet pipe fitting 1041.

The filter 60 may include a housing 600 that forms its exterior. The housing 600 may be detachably mounted to the head body 52. The housing 600 may have its outer shape defined by an upper housing 62 and a lower housing 61. The housing 600 may further include a filter cover 66, which closes the opening of the upper housing 62 and is provided with a water inlet part 663 and a water outlet part 664.

In addition, guide protrusions 625 and 626 for coupling with the head 50 may be formed on the outer surface of the upper housing 62. The upper housing 62 may be inserted through the open bottom surface of the head body 52, and the guide protrusions 625 and 626 may rotate along the inner surface of the head body 52 and move into position to be coupled to the head body 52.

In this process, the housing 600 rotates relative to the head 50, while the water inlet part 663 and the water outlet part 664 remain in a fixed, non-rotating state and move upward to communicate with the flow path inside the head 50. Accordingly, water supplied through the inlet pipe 103 may be purified by passing through the filter 60 and then discharged through the outlet pipe 104.

Below, the head 50 will be described in more detail with reference to the drawings.

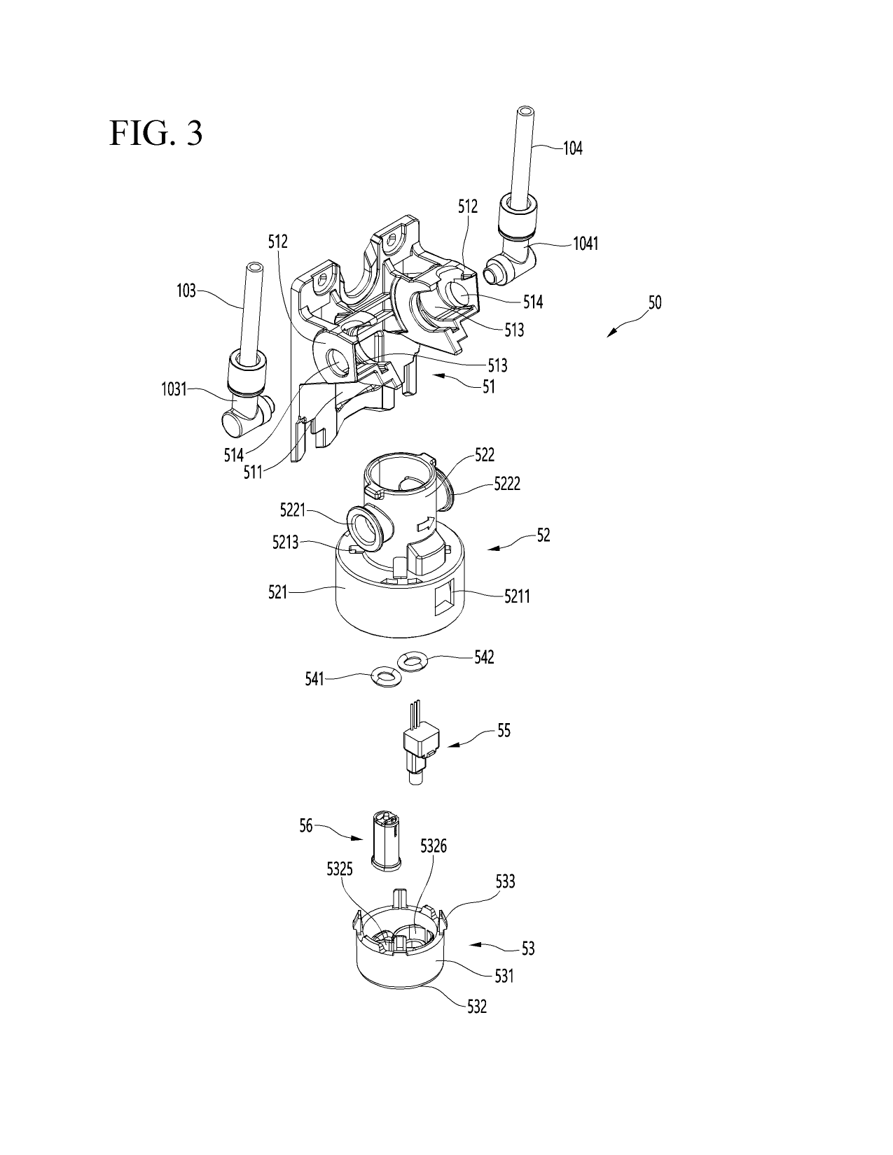

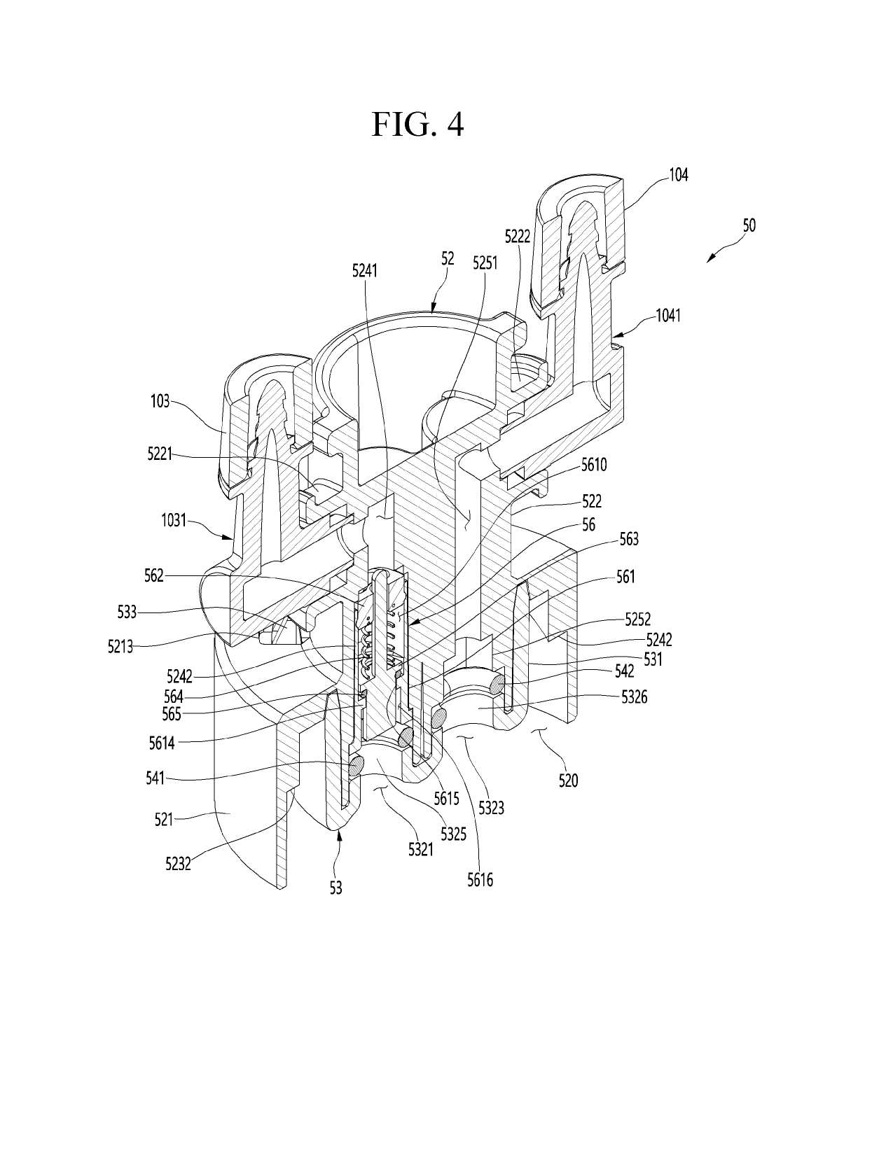

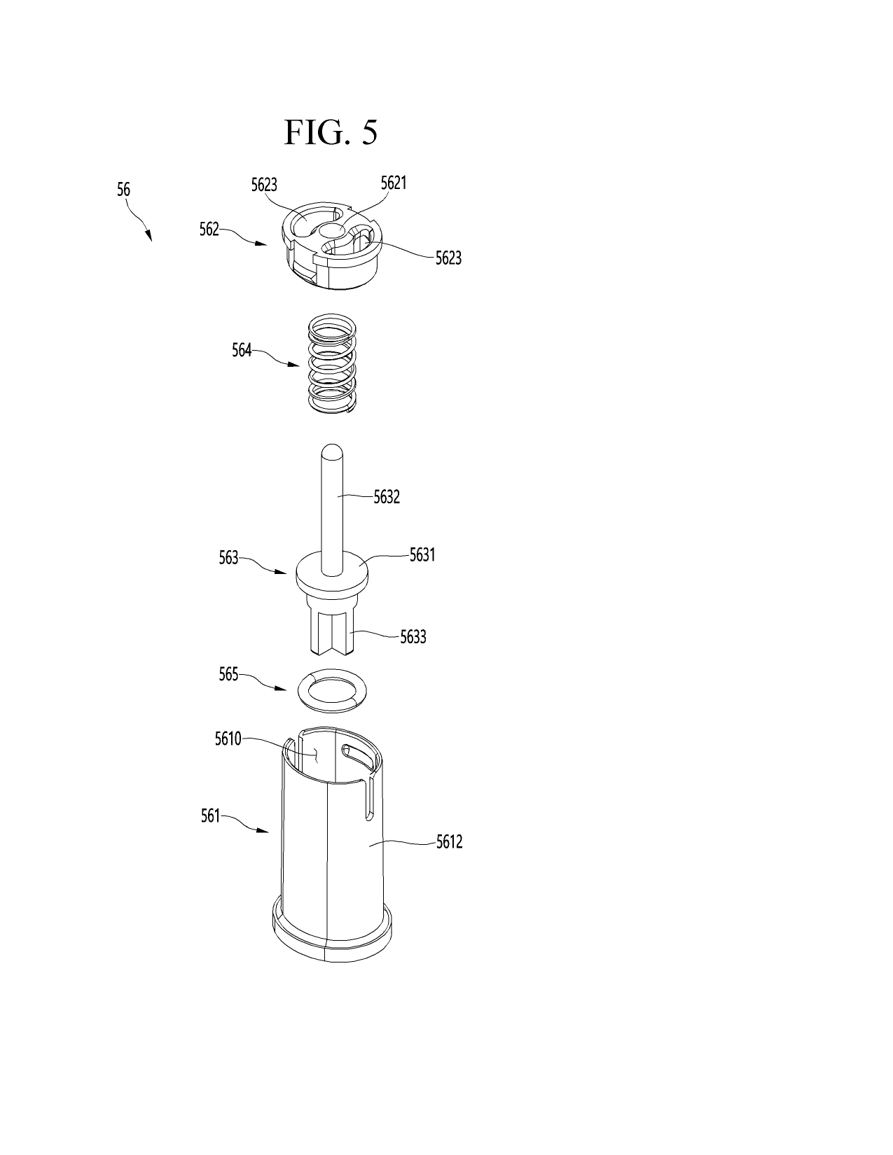

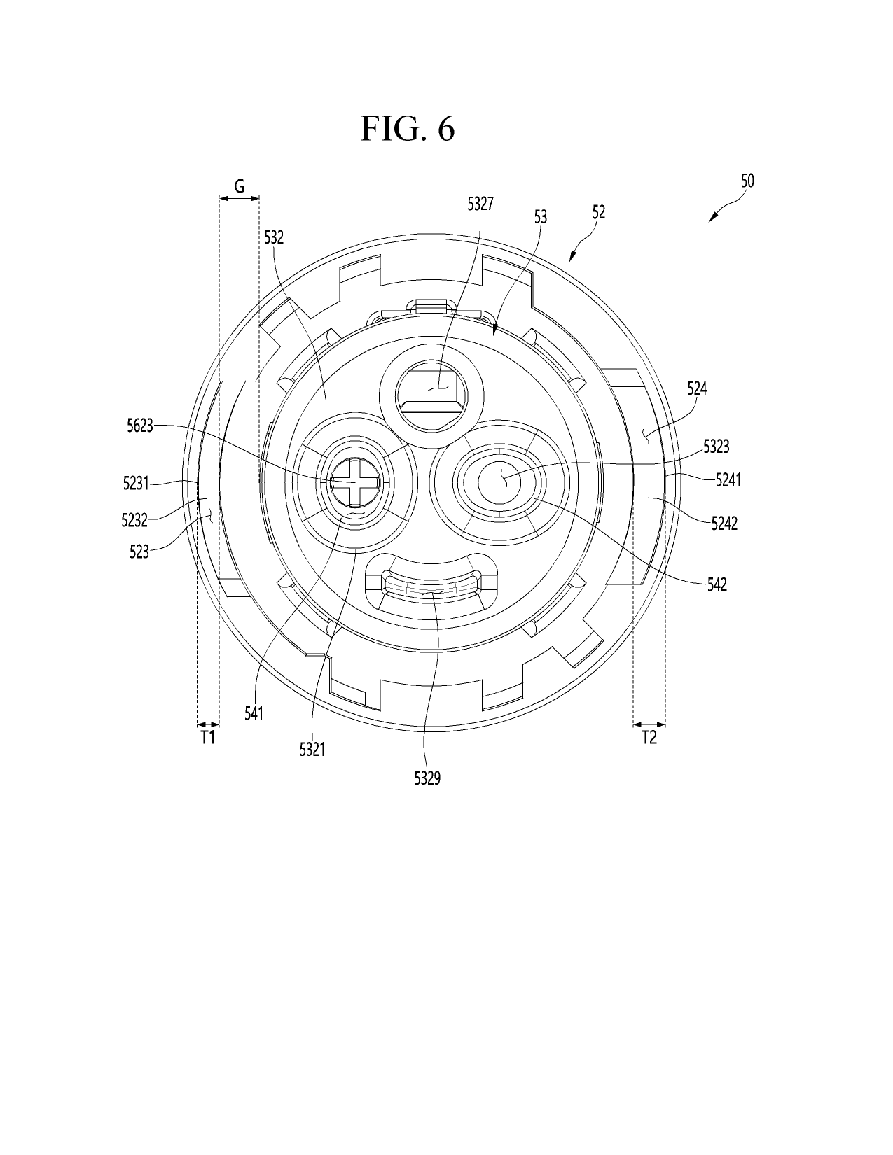

FIG. 3 is an exploded perspective view of the head, and FIG. 4 is a cross-sectional view taken along line 4-4 of FIG. 2, and FIG. 5 is an exploded perspective view of a valve, which is a component of the head, and FIG. 6 is a bottom view of the head.

As illustrated, the head 50 may include a head body 52, the inlet pipe 103, and the outlet pipe 104. The head 50 may further include a mounting member 51.

The mounting member 51 may include a mounting portion 511 that comes into contact with a mounting target such as the cabinet 10, and a head connecting portion 512 to which the head body 52 is rotatably coupled.

A screw may be fastened to the mounting portion 511, thereby allowing the head 50, or the head 50 with the filter 60 mounted, to be securely fixed in place.

The head connecting portions 512 may be formed on both left and right sides of the mounting portion 511, and the head body 52 may be disposed between the pair of head connecting portions 512. A fitting seating part 513, on which fittings 1031 and 1041 are seated, may be formed in the head connecting portions 512. In addition, a seating part opening 514, into which the fittings 1031 and 1041 are axially coupled, may be formed on the side surface of the fitting seating part 513.

The water inlet pipe fitting 1031 and the water outlet pipe fitting 1041 are respectively seated in the fitting mounting parts 513 located on both sides, and can be rotatably disposed by being axially coupled to the seating part openings 514. In addition, the water inlet pipe fitting 1031 and the water outlet pipe fitting 1041 can be rotatably connected to both sides of the head body 52.

The head body 52 may include a head upper 522 and a head lower 521. The head upper 522 may be connected to the water inlet pipe fitting 1031 and the water outlet pipe fitting 1041. A water inlet pipe connection part 5221 connected to the water inlet pipe fitting 1031 and a water outlet pipe connection part 5222 connected to the water outlet pipe fitting 1041 may be provided on both sides of the head upper 522.

The head lower portion 521 may be formed at a lower side of the head upper 522. The head lower 521 may have an open bottom surface to form a coupling space 520 into which the upper end of the filter 60 is coupled. In addition, a check window 5211 may be formed at the center of the front surface of the head lower portion 521 so that the correct mounting state of the filter 60 can be visually confirmed.

In addition, coupling guides 523 and 524 may be formed on the inner surface of the head lower 521 to guide insertion and coupling of the filter 60. As one example, the coupling guides 523 and 524 may include a first guide 523 and a second guide 524. The first guide 523 may be configured to guide insertion and coupling of a first guide protrusion 625 formed on the filter 60, and the second guide 524 may be configured to guide insertion and coupling of a second guide protrusion 626 formed on the filter 60.

The first guide 523 may be recessed into the inner surface of the head lower 521 and extend upward from the lower end of the head lower 521. The first guide 523 may extend up to the check window 5211 so as to guide the first guide protrusion 625 to move along the first guide 523 toward the check window 5211.

The first guide 523 may include a first guide hole 5231, which is opened at the lower end of the head lower 521 and into which the first guide protrusion 625 is inserted. The first guide 523 may further include a first guide portion 5232 extending from one end of the first guide hole 5231 toward the check window 5211.

The first guide portion 5232 may be formed along the circumference of the inner surface of the head lower 521. The first guide portion 5232 may be formed in an inclined or rounded shape. The first guide protrusion 625, inserted into the first guide hole 5231, may move toward the check window 5211 while coming into contact with the first guide portion 5232.

The second guide 524 may be formed at a position facing the first guide 523. In addition, the second guide 524 may be formed in a shape corresponding to the first guide 523, but may be formed to extend in a direction opposite to the extension direction of the second guide 524.

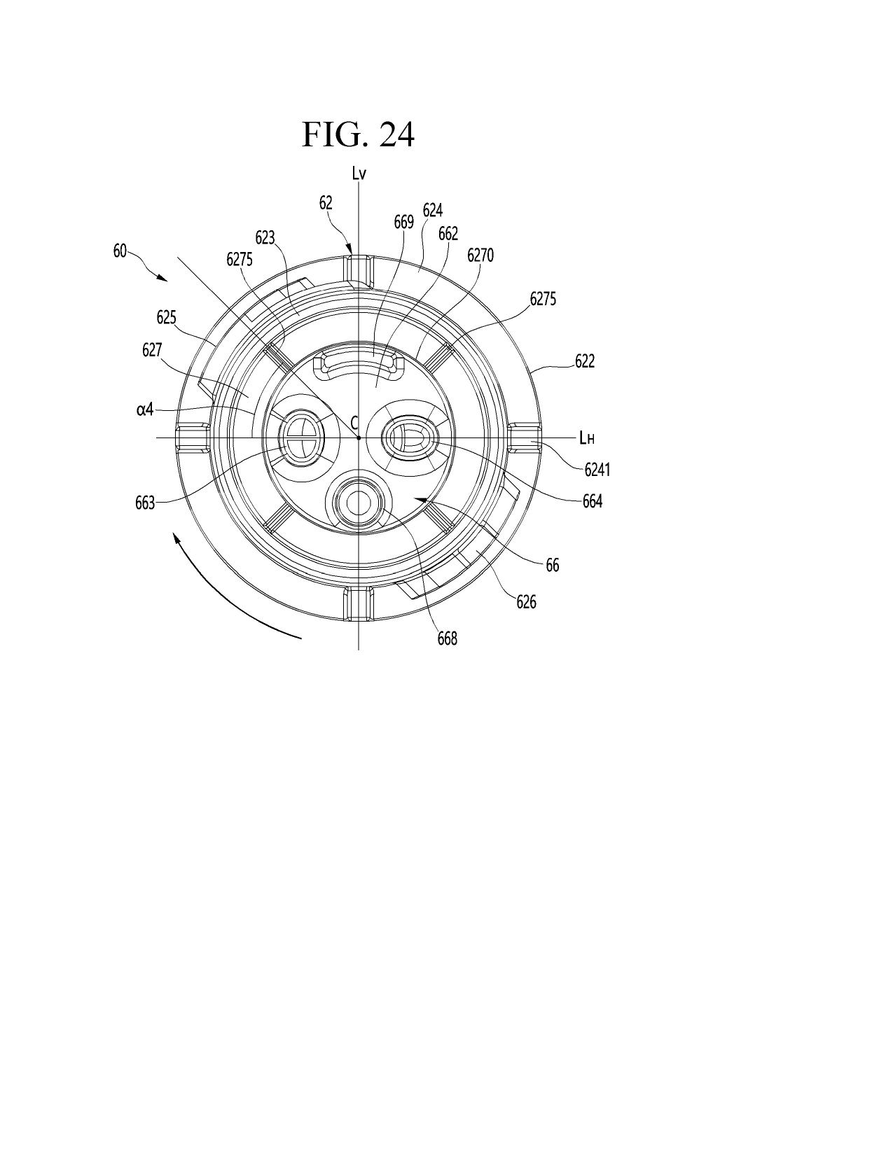

The second guide 524 may include a second guide hole 5241, which is opened at the lower end of the head lower 521 and into which the second guide protrusion 626 is inserted. The second guide hole 5241 may be formed in a direction facing the first guide hole 5231. The second guide 524 may further include a second guide portion 5242 extending from one end of the second guide hole 5241 toward the center of the rear surface of the head lower 521, that is, toward the rear check window 5212 (shown in FIG. 24).

The second guide portion 5242 may be formed along the circumference of the inner surface of the head lower 521 in an inclined or rounded shape and may come into contact with the second guide protrusion 626. The second guide protrusion 626, inserted into the second guide hole 5241, may move while coming into contact with the second guide portion 5242.

Accordingly, the filter housing 600 may be rotated while the first guide protrusion 625 and the second guide protrusion 626 move along the first guide hole 5231 and the second guide hole 5241.

Meanwhile, a head inner 53 may be coupled inside the head body 52. The head inner 53 may be exposed through the open bottom surface of the head body 52. The head inner 53 may be formed with an inlet hole 5321 and an outlet hole 5323 into which the water inlet part 663 and the water outlet part 664 are inserted. In addition, the head inner 53 may be provided with an inlet ring 541 and an outlet ring 542 for sealing the water inlet part 663 and the water outlet part 664.

In detail, the head inner 53 may be formed in a circular shape and may include an inner base 532 forming a bottom surface, and an inner wall 531 extending upward along the circumference of the inner base 532.

The inner base 532 may be formed with the inlet hole 5321 and the outlet hole 5323. The inlet hole 5321 and the outlet hole 5323 may each be formed in an elliptical shape corresponding to the cross-sectional shapes of the water inlet part 663 and the water outlet part 664, respectively. When the first guide protrusion 625 and the second guide protrusion 626 are inserted into and mounted in the first guide hole 5231 and the second guide hole 5241, the water inlet part 663 and the water outlet part 664 may naturally be inserted into the inlet hole 5321 and the outlet hole 5323, respectively. In addition, the inlet hole 5321 and the outlet hole 5323 may be arranged with orientation so as to prevent incorrect installation of the filter 60.

As one example, as illustrated in FIG. 6, the inlet hole 5321 may be formed such that its major axis is arranged in the front-rear direction, and the outlet hole 5323 may be formed such that its major axis is arranged in the left-right direction.

An inlet rim 5325 extending upward may be formed around the inlet hole 5321. The upper end of the inlet rim 5325 may support the inlet ring 541 so that the inlet ring 541 is seated thereon. In addition, an outlet rim 5326 extending upward may be formed around the outlet hole 5323. The upper end of the outlet rim 5326 may support the outlet ring 542 so that the outlet ring 542 is seated thereon. The inlet ring 541 and the outlet ring 542 may each be formed in an elliptical shape that comes into contact with the outer surfaces of the water inlet part 663 and the water outlet part 664, thereby ensuring airtight sealing.

Meanwhile, a filter sensing device 55 for detecting the installation of the filter 60 may be provided inside the head body 52. As one example, the filter sensing device 55 may be a sensor that detects a change in a magnetic field. As another example, the filter sensing device 55 may be implemented as a proximity sensor, a contact switch, or an RFID reader. A wire 550 connected to the filter sensing device 55 may extend upward from the head body 52.

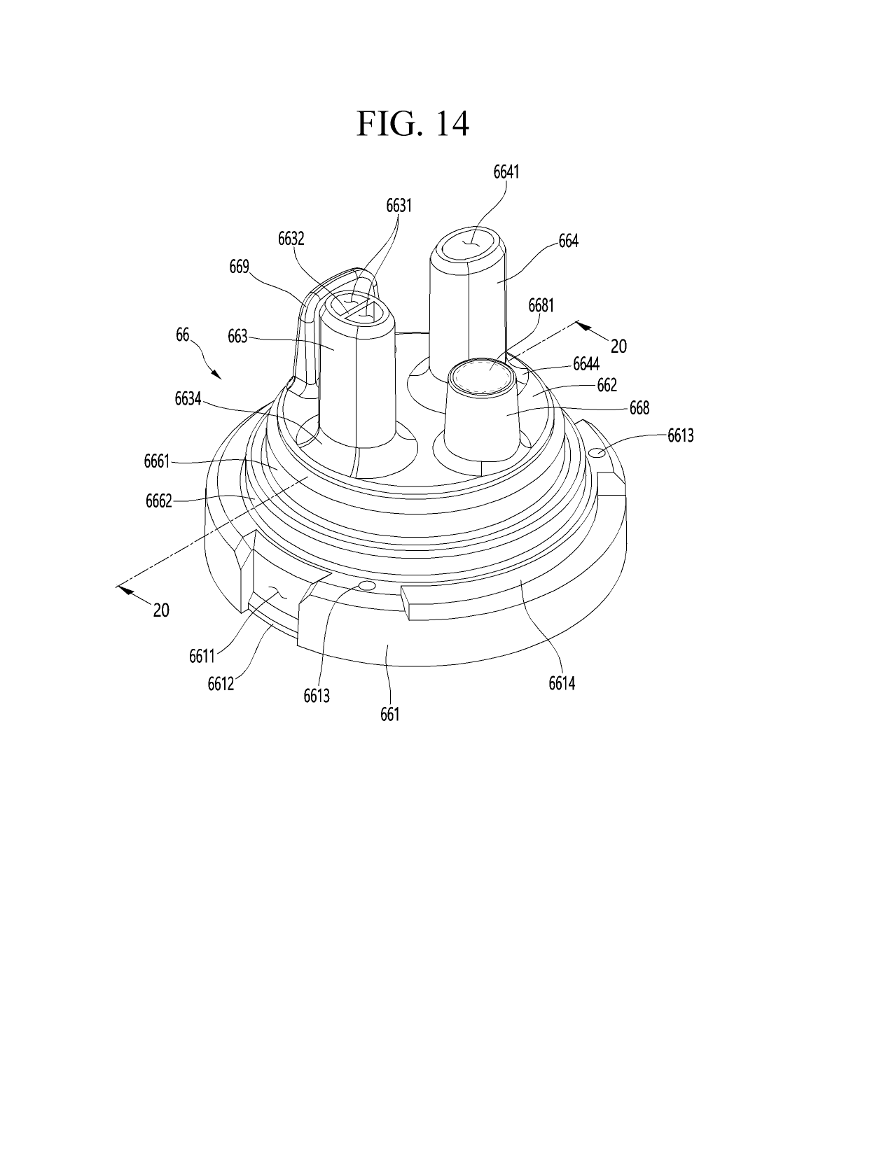

The inner base 532 may be formed with a sensing hole 5237 into which a sensing member 668 (in FIG. 14) described below, is inserted. The filter sensing device 55 may be provided above the sensing hole 5237. Accordingly, when the filter 60 is mounted to the head 50, the sensing member 668may be inserted into the sensing hole 5237, and the filter sensing device 55 may detect the sensing member 668to determine whether the filter 60 is installed.

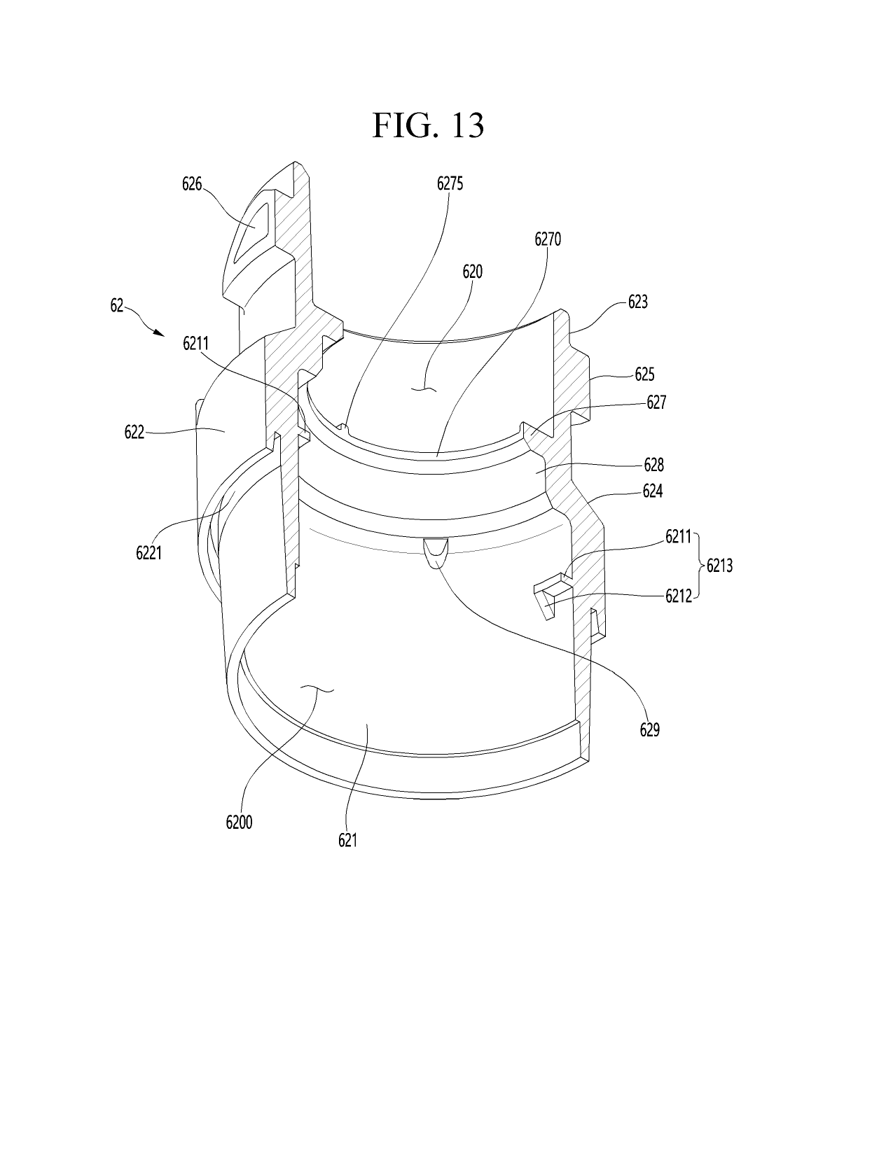

The inner base 532 may be formed with a fixing groove 5329 into which the fixing protrusion 669 is inserted. The fixing groove 5329 may be recessed in a shape corresponding to the fixing protrusion 669 so that the fixing protrusion 669 (in FIG. 13) can be closely fitted therein.

An inner coupling portion 533 may protrude upward from the upper end of the inner wall 531. The inner coupling portion 533 may be coupled to a coupling hole 5213 of the head lower 521.

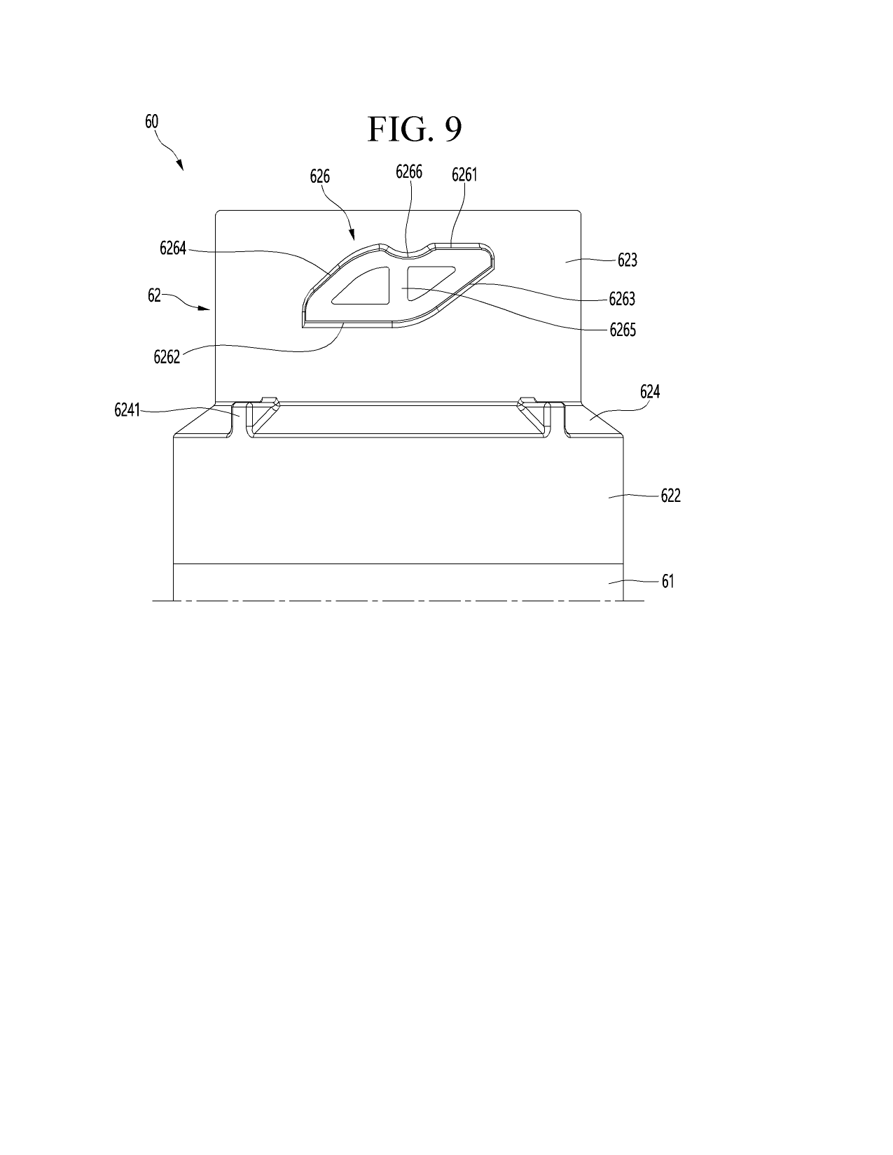

The outer surface of the inner wall 531 may be spaced apart from the inner surface of the head body 52. In this case, the thickness T1 of the first guide portion 5232 may be formed thinner than the thickness T2 of the second guide portion 5242. Accordingly, a gap G between the outer end of the first guide portion 5232 and the outer surface of the inner wall 531 may be formed so that a protrusion extension 6256 of the first guide protrusion 625 (in FIG. 9) can be inserted therein.

In contrast, a gap between the outer end of the second guide portion 5242 and the outer surface of the inner wall 531 may be narrower than the thickness of the protrusion extension 6256, thereby preventing insertion of the protrusion extension 6256.

That is, only the first guide protrusion 625 and the second guide protrusion 626, which respectively correspond to the first guide 523 and the second guide 524, can be inserted into them. In addition, the water inlet part 663 and the water outlet part 664 may also be inserted into the inlet hole 5321 and the outlet hole 5323, respectively, which have corresponding cross-sectional shapes.

In addition, the water inlet part 663 and the water outlet part 664 may be inserted through the inlet ring 541 and the outlet ring 542, which are disposed inside the inlet hole 5321 and the outlet hole 5323, respectively, thereby preventing leakage between the head 50 and the filter 60.

A flow path communicating with the inlet pipe 103, the outlet pipe 104, and the water inlet part 663 and the water outlet part 664 may be formed inside the head body 52. Specifically, an inlet flow path 5241 communicating with the inlet pipe connection 5221 may be formed inside the head body 52, and an outlet flow path 5251 communicating with the outlet pipe connection 5222 may be formed therein.

In addition, a valve mounting portion 5242 connected to the inlet flow path 5241 and configured to receive a valve 56 may be formed inside the head body 52. The valve 56 may be provided above the inlet ring 541. The valve 56 may selectively supply water, fed from the inlet flow path 5241, toward the filter 60, and may be opened and closed depending on whether the filter 60 is installed.

The valve 56 may include a valve case 561, a piston 563, a spring 564, and a valve cap 562.

The valve case 561 may have open upper and lower surfaces and may be formed with a piston receiving portion 5610 inside. A circumferential surface 5612 of the valve case 561 may come into contact with an inner surface of the valve mounting portion 5242. In addition, a piston support 5614 protruding inward may be formed inside the valve case 561.

The piston 563 may be disposed above the piston support 5614 and may move vertically to open and close a case passage 5615. A valve cap 562 may be provided on an upper surface 5611 of the valve case 561. A spring 564 may be disposed between the valve cap 562 and the piston 563 to elastically support the piston 563.

The piston 563 may include a seat portion 5631 that closes the case passage 5615, a contact portion 5633 that protrudes downward from a lower surface of the seat portion 5631 and passes through the case passage 5615, and a rod 5632 that protrudes upward from an upper surface of the seat portion 5631 and passes through the valve cap 562.

The seat portion 5631 may open and close the case passage 5615. When the case passage 5615 is opened by upward movement of the piston 563, water may be supplied toward the water inlet part 663.

Meanwhile, the contact portion 5633 may protrude downward through the case passage 5615 and may come into contact with an upper end of the water inlet part 663 when the filter 60 is installed. A piston ring 565 may be provided at an upper end of the contact portion 5633, i.e., on a lower surface of the seat portion 5631. The piston ring 565 may contact the circumference of the case passage 5615 to seal between the case passage 5615 and the piston 563.

The rod 5632 may extend upward from the center of the seat portion 5631 and may pass through a rod hole 5621 of the valve cap 562. An upper end and a lower end of the spring 564 may be supported by the valve cap 562 and the seat portion 5631, respectively.

The valve cap 562 may cover the upper surface of the valve case 561. A cap through-hole 5623 penetrating the valve cap 562 may be formed therein. Accordingly, when the case passage 5615 is opened by movement of the piston 563, water supplied to the inlet flow path 5241 may flow through the cap through-hole 5623 and the case passage 5615, pass through the valve 56, and be introduced into the water inlet part 663.

In addition, an outlet receiving portion 5252, into which the water outlet part 664 is inserted, may be formed inside the head body 52 and connected to the outlet flow path 5251.

Hereinafter, the filter 60 will be described in detail with reference to the drawings.

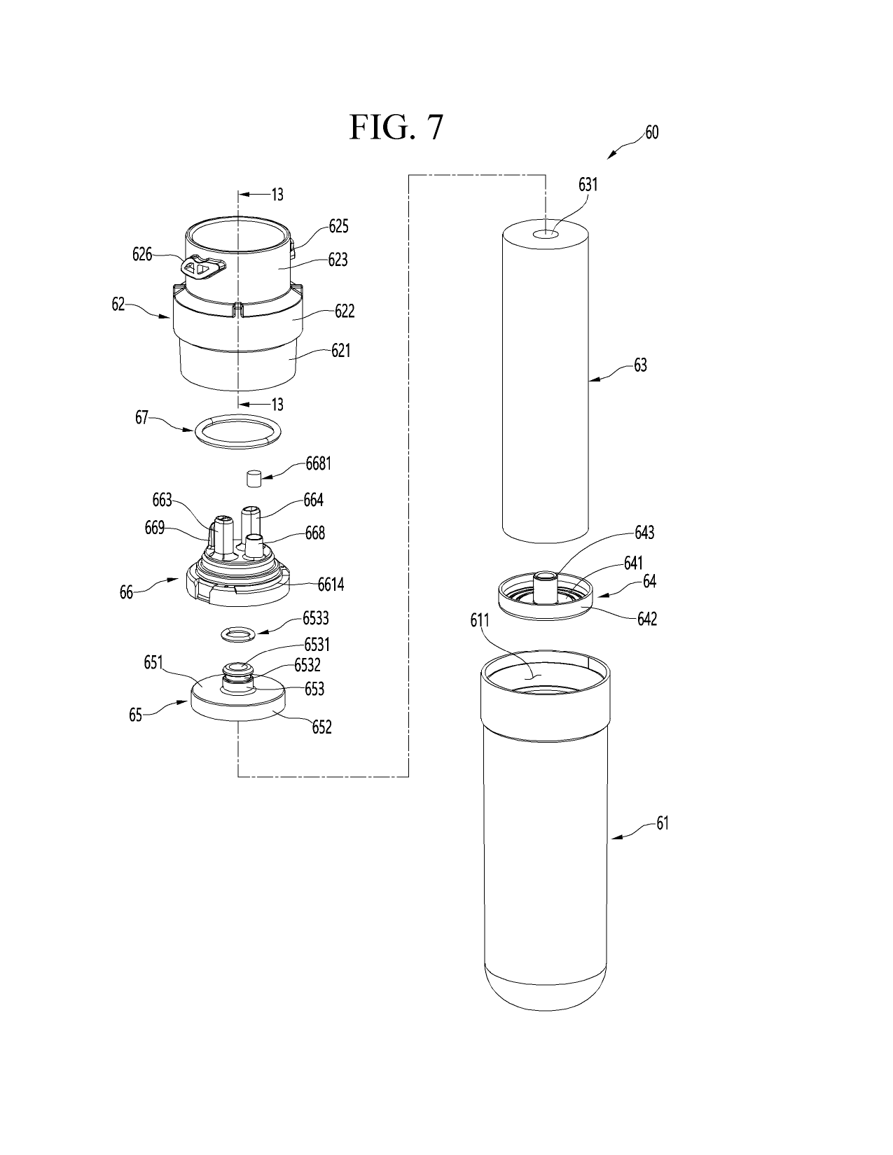

FIG. 7 is an exploded perspective view of the filter.

As illustrated, the filter 60 may include a housing 600 forming an exterior appearance, a filter member 63 disposed inside the housing 600, and a filter cover 66 exposed through an upper surface of the housing 600.

The housing 600 may include an upper housing 62 forming an upper portion of the housing 600 and a lower housing 61 forming a lower portion of the housing 600. The upper housing 62 and the lower housing 61 may be coupled to each other to form a space in which the filter member 63 is accommodated.

The upper housing 62 and the lower housing 61 may form a cylindrical shape in the coupled state, thereby forming the exterior of the filter 60. The upper housing 62 and the lower housing 61 may be made of a plastic material and may be joined to each other by ultrasonic welding or spin welding.

The upper housing 62 may be configured with open upper and lower surfaces, and a space 6200, 620 may be formed inside the upper housing 62 in which the filter cover 66 is rotatably disposed.

As one example, the upper housing 62 may include an upper part 623 inserted into the interior of the head body 52 and a lower part 622 exposed downward from the head body 52. First guide protrusions 625 and second guide protrusions 626 may be formed around the circumference of the upper part 623 so that the filter 60 can be detachably coupled to the head 50.

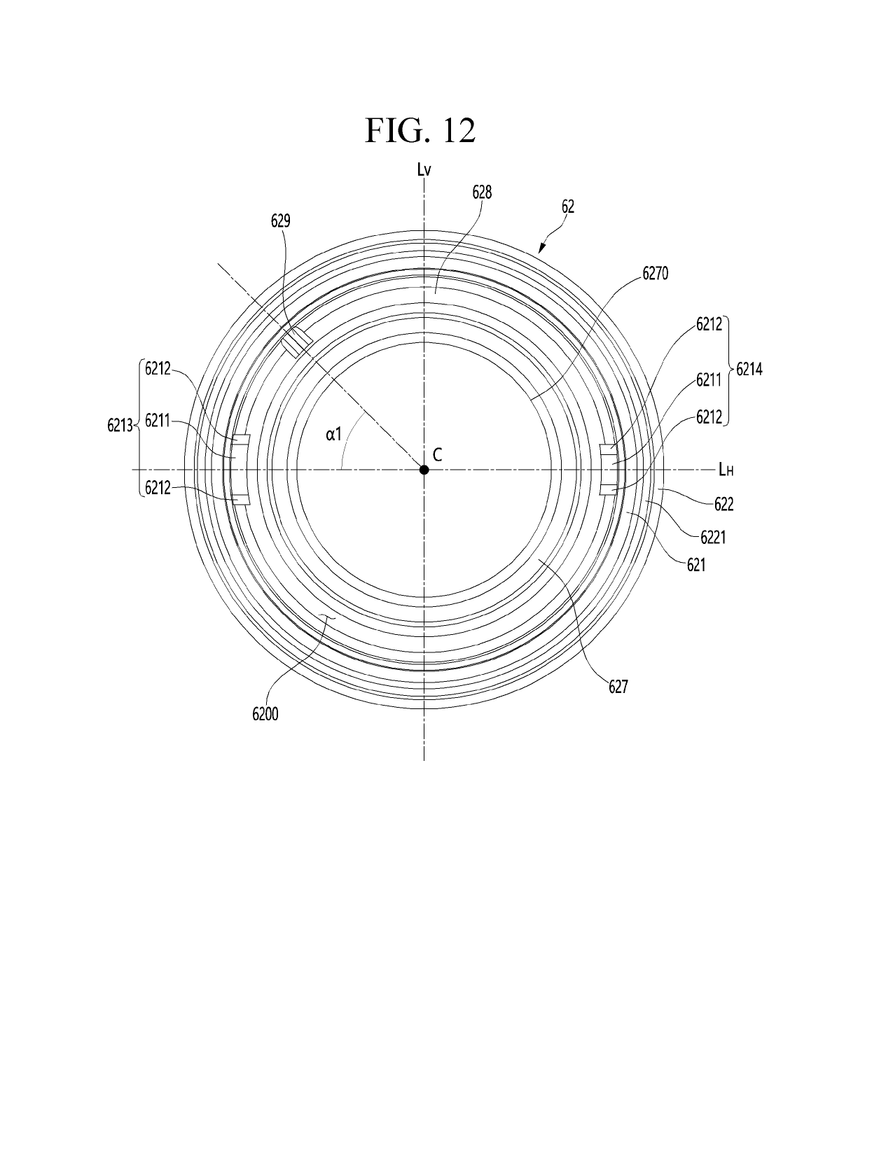

The upper housing 62 may further include a housing coupling portion 621 extending downward beyond the lower part 622. A coupling groove 6221, shown in FIG. 12, into which an upper end of the lower housing 61 is inserted, may be formed between a lower end of the lower part 622 and the housing coupling portion 621. The coupling groove 6221 and the upper end of the lower housing 61 may be welded together to achieve coupling.

The lower housing 61 may have an open upper surface and may form an accommodating space 611 in which the filter member 63 is received. The filter member 63 may be inserted through the open upper surface of the lower housing 61 and accommodated inside the accommodating space 611.

Meanwhile, the housing 600 may rotate relative to the filter cover 66. That is, the filter cover 66 may remain in an aligned state for coupling with the head 50, while the housing 600 rotates to be fastened to the head 50.

The filter cover 66 may be connected to the filter member 63 and an upper supporter 65. Accordingly, the housing 600 may also be considered to rotate relative to the filter cover 66 and the filter member 63, which are coupled together.

The filter member 63 may have a cylindrical shape with a hollow portion 631 passing through its center. The filter member 63 may be formed of a porous material so as to purify water passing through it. As one example, water outside the filter member 63 may pass through the filter member 63, flow into the hollow portion 631, and then flow upward through the hollow portion 631 to supply purified water.

The filter member 63 may be made of various materials and types and may be appropriately selected according to the required purification performance. As one example, the filter member 63 may be implemented as various types of filters such as a membrane filter, a pre-carbon filter, or a sediment filter.

A lower supporter 64 may be provided on a lower surface of the filter member 63. The lower supporter 64 may support the filter 60 from below and may come into contact with a lower surface of the lower housing 61.

The lower supporter 64 may include a supporter bottom surface 641, a lower rim 642, and a lower boss 643. The supporter bottom surface 641 may contact the lower surface of the filter member 63 to support the filter member 63. The lower rim 642 may extend upward along the circumference of the supporter bottom surface 641 to support the lower circumferential edge of the filter member 63. The lower boss 643 may protrude upward from the supporter bottom surface 641 and may be inserted into the lower side of the hollow portion 631 to support an inner surface of the filter member 63.

The upper supporter 65 may be disposed at an upper end of the filter member 63 to fix an upper portion of the filter member 63 and simultaneously guide purified water passing through the hollow portion 631 toward the filter cover 66. The upper supporter 65 may also connect the filter member 63 and the filter cover 66 to each other. Accordingly, the filter member 63 and the filter cover 66 may be in a coupled state by the upper supporter 65, and the housing 600 may rotate relative to the filter member 63 and the filter cover 66.

The filter member 63 may be coupled to the upper supporter 65 and the lower supporter 64, and the upper supporter 65 may be coupled to the filter cover 66. Accordingly, the filter cover 66 may remain stationary together with the filter member 63, and only the housing 600 may rotate.

The upper supporter 65 may include a supporter top surface 651, an upper rim 652, a filter nipple 653, and an upper boss 654. The supporter top surface 651 may contact the upper surface of the filter member 63 to support the filter member 63. The upper rim 652 may extend downward along the circumference of the supporter top surface 651 to support the upper circumferential edge of the filter member 63.

In addition, a filter nipple 653 may protrude upward from the center of the supporter top surface 651. An outlet 6531 communicating with the hollow portion 631 may be formed at an upper end of the filter nipple 653. A sealing groove 5632 into which a nipple seal 6533 is mounted may be formed around the circumference of the filter nipple 653. The filter nipple 653 may be configured to be inserted into a nipple receiving portion 665 of the filter cover 66.

The upper boss 654 may protrude downward from the supporter top surface 651 and may be inserted into an upper portion of the hollow portion 631 to support an inner surface of the filter member 63. The upper boss 654 may be in communication with the filter nipple 653. That is, the filter nipple 653, the upper boss 654, and the hollow portion 631 may be arranged on the same axis and communicate with each other to form a flow path through which water purified by the filter member 63 passes.

The filter cover 66 may be located inside the upper housing 62 and may vertically partition the interior of the upper housing 62. The filter cover 66 may be rotatably mounted to the upper housing 62. A sealing member 67 may be provided between the circumference of the filter cover 66 and the upper housing 62. Accordingly, the filter cover 66 may prevent leakage even while being rotatably mounted to the upper housing 62.

Water inlet part 663 and water outlet part 664 may protrude upward from an upper surface of the filter cover 66. The water inlet part 663 and the water outlet part 664 may be exposed through the open upper surface of the upper housing 62. In addition, a fixing protrusion 669, which is inserted into the fixing groove 5329, may protrude upward from the upper surface of the filter cover 66. A sensing member 668may also protrude upward from the upper surface of the filter cover 66, and a magnet 6681 may be mounted inside the sensing member 668.

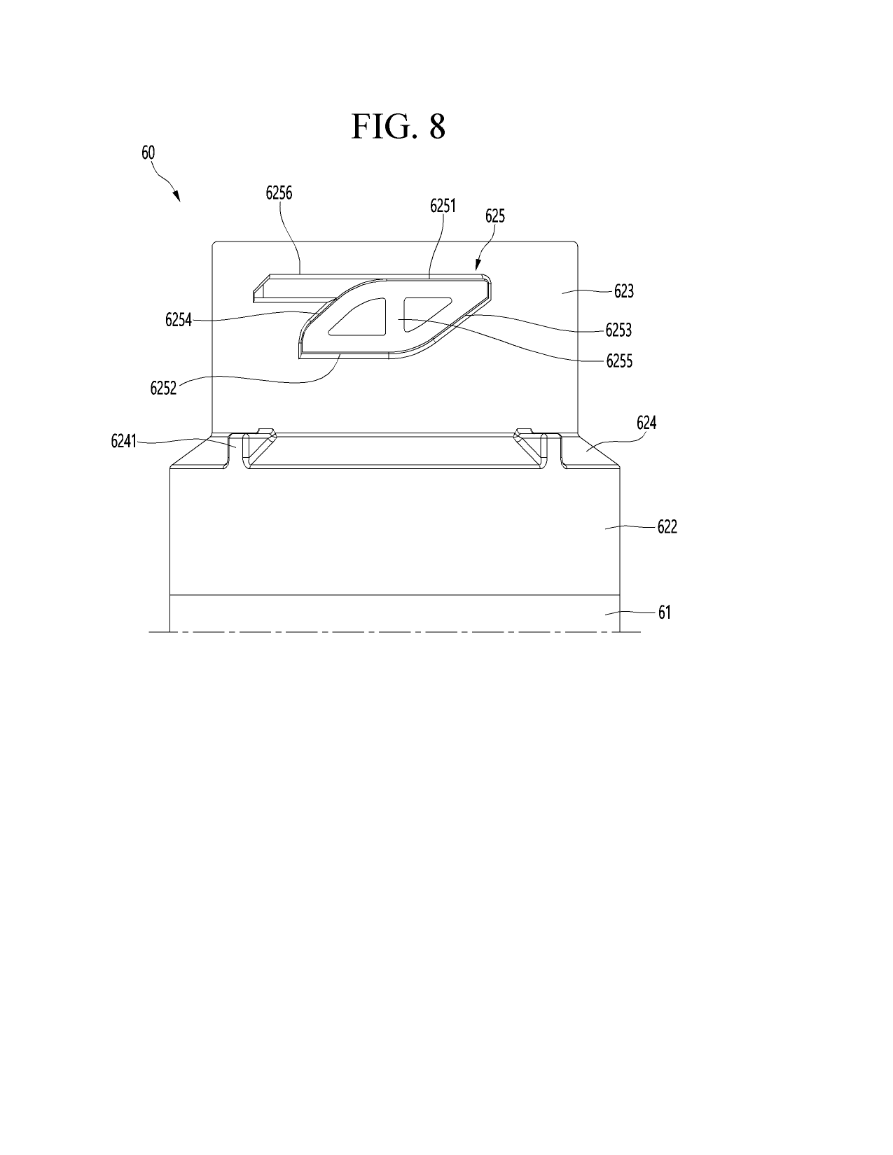

FIG. 8 is a side view of the upper portion of the filter as seen from one side, and FIG. 9 is a side view of the upper portion of the filter as seen from the opposite side.

As illustrated, first guide protrusions 625 and second guide protrusions 626 may protrude from an outer surface of the upper part 623. The first guide protrusions 625 and the second guide protrusions 626 may be formed at positions facing each other with respect to the center of the housing 600. Each first guide protrusion 625 may be formed in a shape insertable into the first guide 523, and each second guide protrusion 626 may be formed in a shape insertable into the second guide 524. The first guide protrusions 625 and the second guide protrusions 626 may have different shapes to prevent incorrect installation of the filter 60 and to guide proper installation.

In particular, the first guide protrusion 625 may come into contact with the first guide 523 and the second guide 524 before the water inlet part 663 and the water outlet part 664 are inserted into the head inner 53. Accordingly, when incorrect installation occurs with respect to the first guide 523, the first guide protrusion 625 may prevent the water inlet part 663 and the water outlet part 664 from coming into contact with the head inner 53, thereby fundamentally preventing deformation or damage of the water inlet part 663 and the water outlet part 664 caused by incorrect installation.

As one example, the first guide protrusion 625 may be formed on the left side with respect to the center of the filter 60. The first guide protrusion 625 may be positioned laterally of the water inlet part 663.

The first guide protrusion 625 may include a first upper portion 6251 forming an upper surface, a first lower portion 6252 forming a lower surface, a first front inclined portion 6253 connecting front ends of the first upper portion 6251 and the first lower portion 6252, and a first rear inclined portion 6254 connecting rear ends of the first upper portion 6251 and the first lower portion 6252. The first upper portion 6251, the first lower portion 6252, the first front inclined portion 6253, and the first rear inclined portion 6254 may protrude from an outer surface of the upper housing 62 with the same thickness. In particular, the first front inclined portion 6253 may be formed to protrude so as to move in a state of contact with the first guide portion 5232, thereby facilitating rotation and upward movement of the filter 60.

The lengths of the first upper portion 6251 and the first lower portion 6252 may be formed to correspond to the size of the first guide hole 5231, so that the first guide protrusion 625 is inserted into the first guide hole 5231 when the filter 60 moves upward. A connecting rib 6255 vertically connecting the first upper portion 6251 and the first lower portion 6252 may further be formed.

Meanwhile, a protrusion extension 6256 extending rearward may be formed at a rear end of the first upper portion 6251. The protruding thickness of the protrusion extension 6256 may be smaller than the protruding thickness of the first upper portion 6251. In addition, the protruding thickness of the protrusion extension 6256 may be smaller than a gap G between the head inner 53 and the first guide portion 5232. Accordingly, when the first guide protrusion 625 is inserted into the first guide hole 5231, the protrusion extension 6256 may be inserted between the first guide portion 5232 and the outer surface of the head inner 53, thereby allowing insertion and rotational movement of the first guide protrusion 625.

The second guide protrusion 626 may include a second upper portion 6261 forming an upper surface, a second lower portion 6262 forming a lower surface, a second front inclined portion 6263 connecting front ends of the second upper portion 6261 and the second lower portion 6262, and a second rear inclined portion 6264 connecting rear ends of the second upper portion 6261 and the second lower portion 6262. The second upper portion 6261, the second lower portion 6262, the second front inclined portion 6263, and the second rear inclined portion 6264 may protrude from the outer surface of the upper part 623 with the same thickness. In particular, the second front inclined portion 6263 may be formed to protrude so as to move in a state of contact with the second guide portion 5242. The protruding thickness of the second guide protrusion 626 may be the same as that of the first guide protrusion 523.

The lengths of the second upper portion 6261 and the second lower portion 6262 may be formed to correspond to the size of the second guide hole 5241 so that the second guide protrusion 626 is inserted into the second guide hole 5241 when the filter 60 moves upward. A connecting rib 6265 vertically connecting the second upper portion 6261 and the second lower portion 6262 may further be formed.

In addition, a restricting groove 6266 recessed downward may be formed in the second upper portion 6261. The restricting groove 6266 may engage with a restricting portion 5213 protruding from the head 50 when the housing 600 is fully rotated, thereby restraining the filter 60.

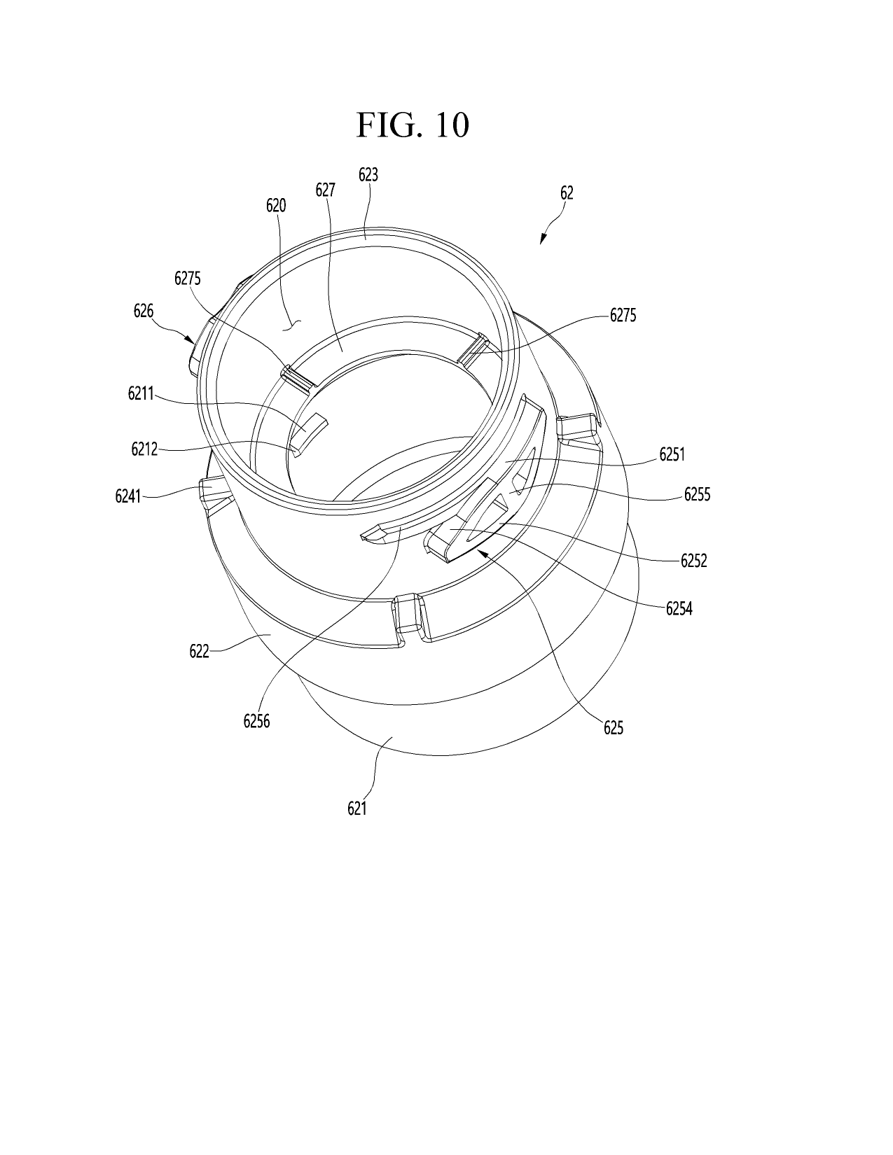

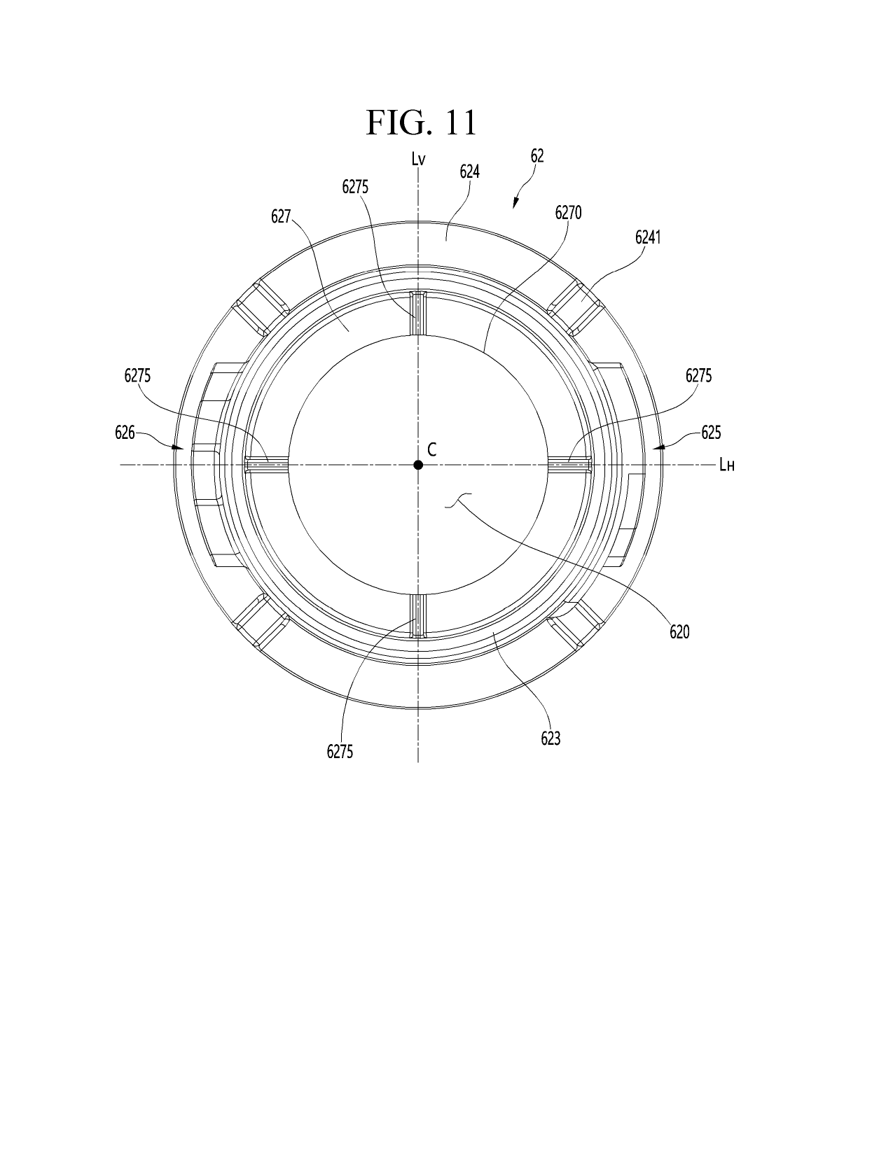

FIG. 10 is a perspective view of the upper housing of the filter as seen from above, and FIG. 11 is a top plan view of the upper housing, and FIG. 12 is a bottom view of the upper housing, and FIG. 13 is a sectional perspective view taken along line 13-13 of FIG. 7.

As illustrated, the upper housing 62 may include an upper part 623 and a lower part 622. The upper part 623 may have a smaller diameter than the lower part 622. A connecting surface 624 having a downward slope may be formed between the lower end of the upper part 623 and the upper end of the lower part 622. A housing rib 6241 protruding upward may be formed on the connecting surface 624.

The housing rib 6241 may be adjacent to the lower end of the head body 52 when the filter 60 is mounted. Accordingly, the complete engagement of the filter 60 can be visually confirmed through the gap between the housing rib 6241 and the head body 52.

In addition, the housing rib 6241 may serve as a guide for positioning a jig during rotational welding of the upper housing 62 and the lower housing 61. A plurality of housing ribs 6241 may be formed along the connecting surface 624, and the housing ribs 6241 may be arranged symmetrically with respect to the center of the upper housing 62.

Meanwhile, a protrusion may be formed inside the upper housing 62. The protrusion may include a first protrusion 627. The protrusion may further include a second protrusion 628. The first protrusion 627 may partition the interior of the upper housing 62 into an upper space 620, in which an upper surface of the filter cover 66 is exposed, and a lower space 6200, in which a lower end of the filter cover 66 is rotatably accommodated.

The first protrusion 627 may be formed on the upper part 623. The first protrusion 627 may protrude toward the center of the upper housing 62 and may form an upper opening 6270 through which the filter cover 66 passes. The first protrusion 627 may support the circumference of the filter cover 66 so that the filter cover 66 is not separated upward even if the pressure inside the filter 60 increases.

A second protrusion 628 may be formed below the first protrusion 627. The second protrusion 628 may be formed in a stepped manner continuously from a lower end of the first protrusion 627. The second protrusion 628 may protrude from an inner surface of the upper housing 62 toward the center of the upper housing 62.

Accordingly, the inner surface of the upper housing 62, the second protrusion 628, and the first protrusion 627 may be sequentially formed in a stepped manner. The stepped shape of the first protrusion 627 and the second protrusion 628 may allow the sealing member 67 to be disposed, and the filter cover 66 may be rotatably disposed inside the upper housing 62.

Meanwhile, a restricting protrusion 629 may be formed on a lower surface of the second protrusion 628. The restricting protrusion 629 may protrude downward at a position corresponding to a restricting groove 6614 formed in the filter cover 66. When the filter cover 66 is mounted inside the upper housing 62, the restricting protrusion 629 may be inserted into the restricting groove 6614. Accordingly, when the upper housing 62 rotates, the restricting protrusion 629 may move along the restricting groove 6614.

In addition, the restricting protrusion 629 may contact one end of the restricting groove 6614 when the housing 600 is in an aligned state before the filter 60 is mounted to the head 50. The restricting protrusion 629 may contact the other end of the restricting groove 6614 when the housing 600 has completed its rotation and the filter 60 is coupled to the head 50. Accordingly, the restricting protrusion 629 can move only within the region of the restricting groove 6614, and the housing 600 can rotate only by the rotation angle defined by the restricting protrusion 629. For example, the rotation angle of the restricting protrusion 629 may be 90°.

A support protrusion 6213, 6214 may be formed below and spaced apart from the second protrusion 628. The support protrusion 6213, 16214 may be configured to support the filter cover 66 from below when the filter cover 66 is mounted inside the upper housing 62.

The support protrusions 6213, 6214 may protrude from the inner surface of the upper housing 62 and be formed at positions corresponding to the lower end of the filter cover 66. Multiple support protrusions 6213, 6214 may be provided at the same height. The support protrusions 6213, 6214 may include a first support protrusion 6213 and a second support protrusion 6214 that are disposed to face each other. The first support protrusion 6213 and the second support protrusion 6214 may be formed with different sizes so as to prevent incorrect assembly when coupled to the filter cover 66.

The first support protrusion 6213 may protrude along the inner surface of the upper housing 62 and may include a horizontal support portion 6211 formed to correspond in size to the first rim groove 6611 of the filter cover 66, and vertical support portions 6212 extending downward from both ends of the horizontal support portion 6211.

The second support protrusion 6214 may have the same shape as the first support protrusion 6213 but be smaller in size. Specifically, the second support protrusion 6214 may protrude along the inner surface of the upper housing 62 and include a horizontal support portion 6211 formed to correspond in size to the second rim groove 6615 of the filter cover 66, and vertical support portions 6212 extending downward from both ends of the horizontal support portion 6211. In this case, the horizontal support portion 6211 of the first support protrusion 6213 may be formed larger than the horizontal support portion 6211 of the second support protrusion 6214.

Meanwhile, the first support protrusion 6213 and the second support protrusion 6214 may be located on a horizontal extension line LH passing through the center C of the upper housing 62. The restricting protrusion 629 may be positioned at a location spaced clockwise from the horizontal extension line LH by a first set angle α1. For example, the first set angle α1 may be 45°. Therefore, when the filter cover 66 is mounted inside the upper housing 62 in an aligned state, the first support protrusion 6213 and the second support protrusion 6214 may pass through the first rim groove 6611 and the second rim groove 6615, and the restricting protrusion 629 may naturally be inserted into the restricting groove 6614.

Meanwhile, due to the characteristic structure in which the housing 600 rotates when the filter 60 is installed, the filter cover 66—namely, the water inlet part 663 and the water outlet part 664—must necessarily be aligned relative to the housing 600 before being coupled with the head 50.

Specifically, when the filter cover 66 is mounted to the upper housing 62, the water inlet part 663 and the water outlet part 664 may be aligned with a specific orientation within the upper housing 62. The user may visually confirm the alignment state of the water inlet part 663 and the water outlet part 664 by means of an alignment portion 6275, thereby easily checking their positioning.

Specifically, as illustrated in FIG. 11, an alignment portion 6275 may be formed on an upper surface 6271 of the first protrusion 627 of the filter 60. The alignment portion 6275 may be formed on upper, lower, left, and right sides in directions intersecting each other. The alignment portion 6275 may protrude from or be recessed into the upper surface 6271 of the first protrusion 627 so as to be exposed when the filter is viewed from above. In another example, one or two alignment portions 6275 may be formed on left and right sides with respect to the center of the upper housing 62.

The alignment portion 6275 may extend from the outer end of the first protrusion 627 toward the center of the upper housing 62. The alignment portion 6275 may be located on both the vertical extension line LV and the horizontal extension line LH passing through the center of the upper housing 62. In this case, the first guide protrusion 625 and the second guide protrusion 626 may also be located on the horizontal extension line LH.

The alignment portion 6275 may visualize the alignment state of the water inlet part 663 and the water outlet part 664 according to the rotation of the housing 600. For example, before the filter 60 is mounted to the head 50, the water inlet part 663 and the water outlet part 664 formed on the filter cover 66 may be arranged on the horizontal extension line LH together with the alignment portion 6275 disposed on the left and right sides. In addition, the fixing protrusion 669 and the sensing member 668 may be arranged on the vertical extension line LV together with the alignment portion 6275 disposed on the front and rear sides.

That is, when the upper surface of the filter 60 is viewed from above before being mounted to the head 50, it may be visually confirmed that the alignment portion 6275, the water inlet part 663, and the water outlet part 664 are located on the same straight line VH. This allows the user to determine that the filter cover 66 is in a normal alignment state and ensures proper coupling with the head 50.

Hereinafter, the filter cover 66 will be described in more detail with reference to the drawings.

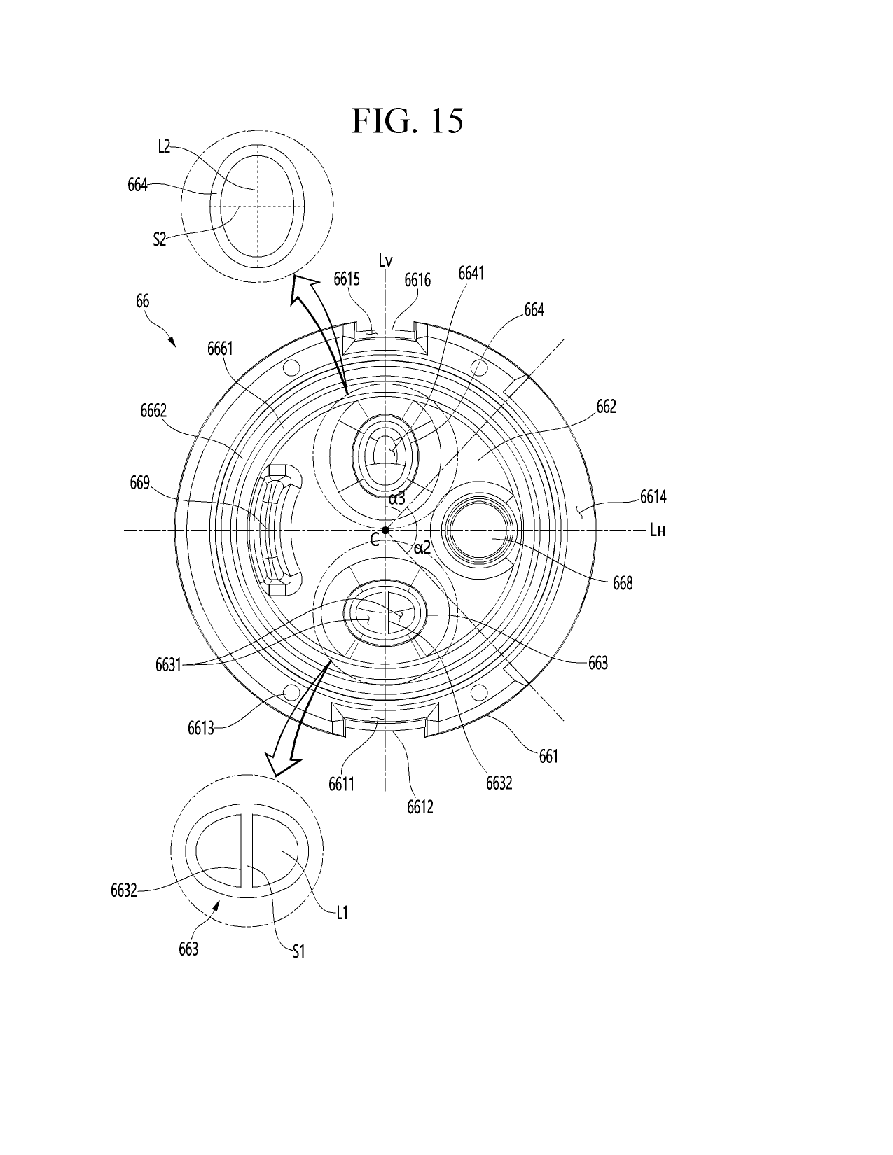

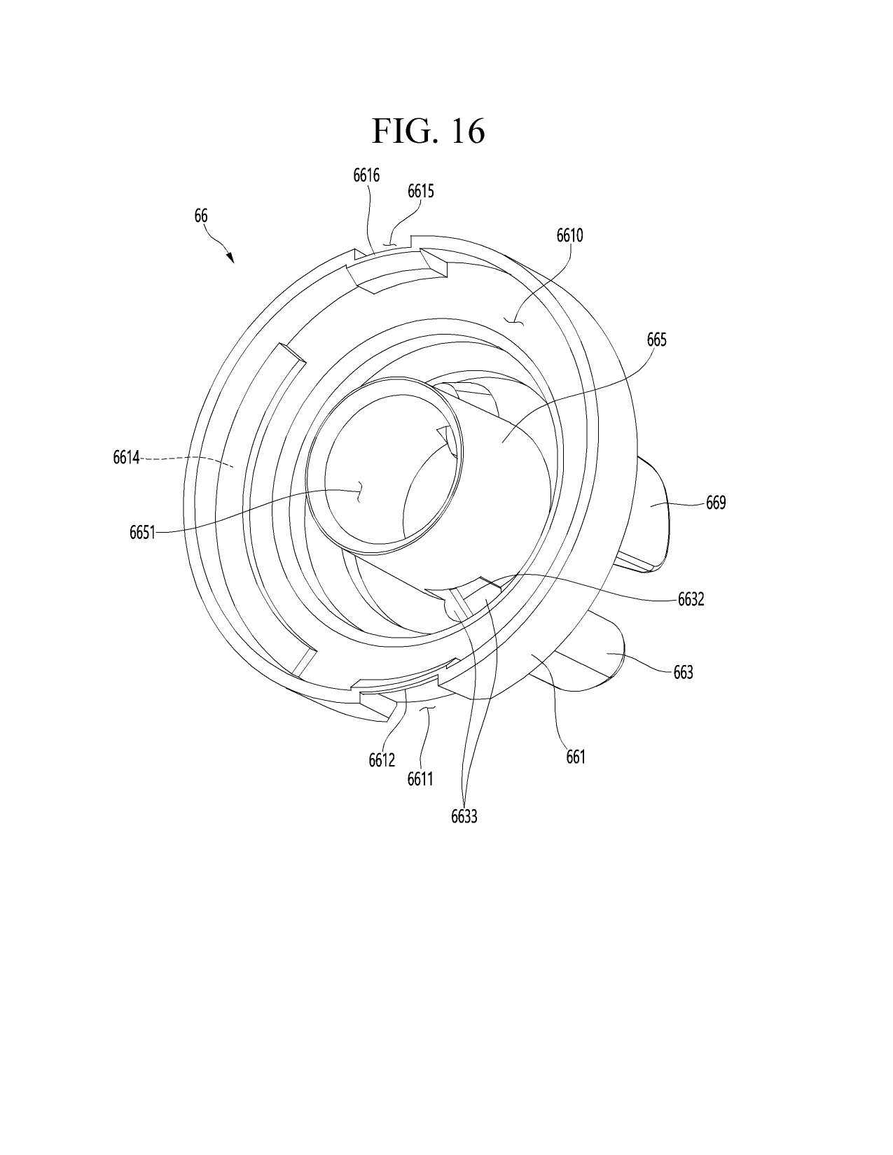

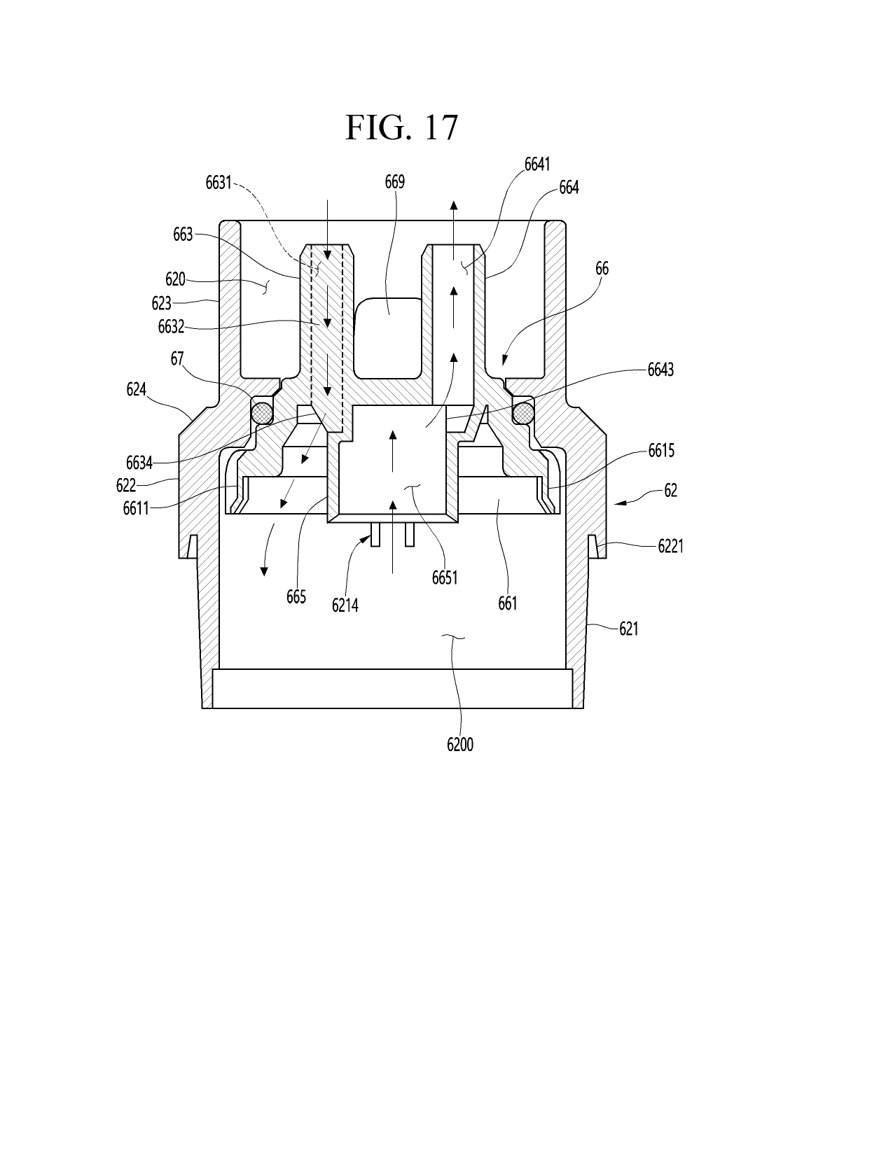

FIG. 14 is a perspective view of the filter cover of the filter as seen from above, and FIG. 15 is a top plan view of the filter cover, and FIG. 16 is a perspective view of the filter cover as seen from below, and FIG. 17 is a longitudinal sectional view showing a state in which the upper housing and the filter cover are assembled.

As illustrated, the filter cover 66 may have an open bottom surface and may be formed in a circular shape when viewed from above. A cover rim 661 may be formed at a lower end of the filter cover 66, and the cover rim 661 may contact an inner surface of the upper housing 62.

A pair of rim grooves 6611, 6615 and rim hooks 6612, 6616 may be formed in the cover rim 661. The rim grooves 6611, 6615 may extend from the lower end to the upper end of the cover rim 661. The rim grooves 6611, 6615 may be formed at positions corresponding to the support protrusions 6213, 6214 and may formed allowing the support protrusions 6213, 6214 to pass through.

The rim grooves 6611, 6615 may include a first rim groove 6611 and a second rim groove 6615. The first rim groove 6611 may be formed to have a size corresponding to the insertion of the first support protrusion 6213. The second rim groove 6615 may be formed to have a size corresponding to the insertion of the second support protrusion 6214. In other words, the first rim groove 6611 may be formed larger than the second rim groove 6615. Accordingly, when the filter cover 66 is coupled with the upper housing 62, incorrect assembly can be prevented, and proper directional coupling can be ensured.

In addition, the rim hooks 6612, 6216 may be formed at lower ends of the rim grooves 6611, 6615. After the support protrusions 6213, 6214 pass through the rim grooves 6611, 6615 and the rim hooks 6612, 6616, they may support the lower end of the filter cover 66. The filter cover 66 may thus remain fixedly mounted to the upper housing 62. During rotation of the housing 600, the support protrusions 6213, 6214 may move along the lower end of the cover rim 661.

A stepped portion 6661, 6662 having a smaller diameter than the cover rim 661 may protrude upward from an upper end of the cover rim 661.

Meanwhile, a restricting groove 6614 into which the restricting protrusion 629 is inserted may be formed at an upper end of the cover rim 661. The restricting groove 6614 may be formed between the cover rim 661 and the stepped portion 6662. The restricting groove 6614 may be formed on a surface that contacts a lower surface of the second protrusion 628 when the filter cover 66 is mounted to the upper housing 62.

One end of the restricting groove 6614, a vertical extension line LV passing through the center C of the filter cover 66 and the rim grooves 6611 and 6615 disposed on both sides, may be spaced apart by a third set angle α3. The third set angle α3 may be equal to the first set angle α1 formed between the restricting protrusion 629 and the vertical extension line LV. Accordingly, when the filter cover 66 is inserted upward from below the upper housing 62 and is aligned so that the support protrusions 6213 and 6214 pass through the rim grooves 6611 and 6615, the restricting protrusion 629 may be inserted into the inside of the restricting groove 6614.

One end of the restricting groove 6614 may contact the restricting protrusion 629 when the housing 600 is in a non-rotated state before the filter 60 is installed. The other end of the restricting groove 6614 may contact the restricting protrusion 629 when the housing 600 is in a fully rotated state during installation of the filter 60.

That is, as the housing 600 rotates, the restricting protrusion 629 may contact both ends of the restricting groove 6614, thereby allowing the housing 600 to rotate by a second set angle α2. In one example, the second set angle α2 may be approximately 90°. For this purpose, the restricting groove 6614 may have a predetermined length such that the housing 600 is allowed to rotate by about 90°. In addition, the restricting groove 6614 may be formed on one side of the filter cover 66 corresponding to the restricting protrusion 629, rather than on the rim 661 of the cover.

Meanwhile, a plurality of contact protrusions 6613 may be formed on an upper surface of the cover rim 661. The contact protrusions 6613 may be formed along the cover rim 661, for example, three to four contact protrusions 6613 may be spaced apart at regular intervals. The contact protrusions 6613 may contact an inner surface of the upper housing 62. Accordingly, the outer surface of the filter cover 66 and the inner surface of the upper housing 62 may not contact each other entirely but only partially. Thus, the upper housing 62 may rotate with minimized friction against the stationary filter cover 66, ensuring smooth rotational operation.

The stepped portion 666 may be configured in multiple stages and may have a shape corresponding to the protruding and recessed shapes of the inner surface of the upper housing 62. As one example, the stepped portion 666 may include a second stepped portion 6662 at an upper end of the cover rim 661 and a first stepped portion 6661 above the second stepped portion 6662. The sealing member 67 may be seated between the first stepped portion 6661 and the second stepped portion 6662 to hermetically seal a space between the upper housing 62 and the filter cover 66. In addition, the first stepped portion 6661 may close the upper opening 6270 of the first protrusion 627.

An inner upper surface 662, which is exposed through the upper opening 6270, may be formed above the first stepped portion 6661. The inner upper surface 662 may be formed in a circular shape corresponding to the upper opening 6270 and may form the same plane as the upper surface of the first protrusion 627.

The inner upper surface 662 may be provided with the water inlet part 663 and the water outlet part 664, which may also be referred to as an inlet nipple and an outlet nipple, respectively. The water inlet part 663 and the water outlet part 664 may be spaced apart from each other at positions facing each other and may be formed at the same height. The inner upper surface 662 may further have the fixing protrusion 669 and the sensing member 668 protruding upward. The fixing protrusion 669 and the sensing member 668 may be arranged in a direction intersecting with the arrangement direction of the water inlet part 663 and the water outlet part 664.

In addition, the height of the fixing protrusion 669 and the sensing member 668 may be formed lower than the height of the water inlet part 663 and the water outlet part 664. Accordingly, when the filter 60 is mounted to the head 50, the water inlet part 663 and the water outlet part 664 may first be inserted into the inlet hole 5321 and the outlet hole 5323. In other words, since the water inlet part 663 and the water outlet part 664 are formed with greater height, they can be coupled to the head inner 53 during insertion and mounting without interference from other components 668, 669.

Meanwhile, the water inlet part 663 and the water outlet part 664 may each be formed in an elliptical shape when viewed from above. The water inlet part 663 and the water outlet part 664 may be arranged in mutually different directions when viewed from above. Accordingly, when the filter 60 is mounted to the head 50, the water inlet part 663 and the water outlet part 664 may be coupled to the inlet hole 5321 and the outlet hole 5323 with a defined orientation. In other words, the orientation of the cross-sectional shapes of the water inlet part 663 and the water outlet part 664 may prevent incorrect installation of the filter 60 and ensure proper mounting.

For example, the water inlet part 663 and the water outlet part 664 may be arranged such that the major axes of their respective elliptical cross-sections are oriented in intersecting directions. Specifically, the water inlet part 663 may be arranged so that its major axis L1 is oriented in the front-rear direction and its minor axis S1 is oriented in the left-right direction. The major axis L1 of the water inlet part 663 may be positioned on the same line as the vertical extension line LV, which is aligned with the alignment portion 6275 that is arranged above and below with respect to the center of the filter cover.

The water outlet part 664 may be arranged so that its major axis L2 is oriented in the left-right direction and its minor axis S2 is oriented in the front-rear direction. In other words, the extended line of the major axis of the cross-section of the water inlet part 663 and the extended line of the major axis L2 of the cross-section of the water outlet part 664 may intersect perpendicularly. Additionally, the major axis L2 of the water outlet part 664 may be positioned on the same line as the horizontal extension line LH, which is aligned with the alignment portion 6275 arranged to the left and right with respect to the center of the filter cover.

In this way, since the water inlet part 663 and the water outlet part 664 have an elliptical cross-sectional shape and their major axes L1 and L2 extend in intersecting directions, the filter cover 66 is prevented from rotating even when torque is generated during the rotation of the housing 600.

The filter cover 66 may include a nipple receiving portion 665. The nipple receiving portion 665 may extend downward from the inner upper surface 662 and may be disposed along the centerline of the filter cover 66. The nipple receiving portion 665 may be formed in a cylindrical shape with an open bottom to form a second space 6651 into which the filter nipple 653 is inserted.

The nipple receiving portion 665 may be formed in a shape corresponding to the outer diameter of the nipple sealing 6533. An outer end of the nipple receiving portion 665 may come into contact with a lower end of the water inlet part 663 and a lower end of the water outlet part 664, respectively. By the nipple receiving portion 665, the interior of the filter cover 66 may be partitioned into a first space 6610 into which water flows through the water inlet part 663 and a second space 6651 from which purified water is discharged toward the water outlet part 664.

In detail, the water inlet part 663 may be in communication with the first space 6610. A lower end of the water inlet part 663 may form an inlet outlet 6633 that communicates with the first space 6610.

An inlet contact portion 6632 may be formed inside the water inlet part 663 to partition an internal water inlet flow path 6631 of the water inlet part 663. The inlet contact portion 6632 may extend from an upper end of the water inlet part 663 to the inlet outlet 6633. In addition, the inlet contact portion 6632 may be formed along the minor axis S1 of the elliptical cross-section of the water inlet part 663.

The water outlet part 664 may be in communication with the second space 6651. A lower end of the water outlet part 664 may form an outlet inlet 6643 that communicates with the second space 6651. An outlet flow path 6641 may be formed inside the water outlet part 664. The cross-sectional shape of the outlet flow path 6641 may be formed in an elliptical shape and may be arranged in a direction intersecting with the cross-sectional shape of the water inlet flow path 6631.

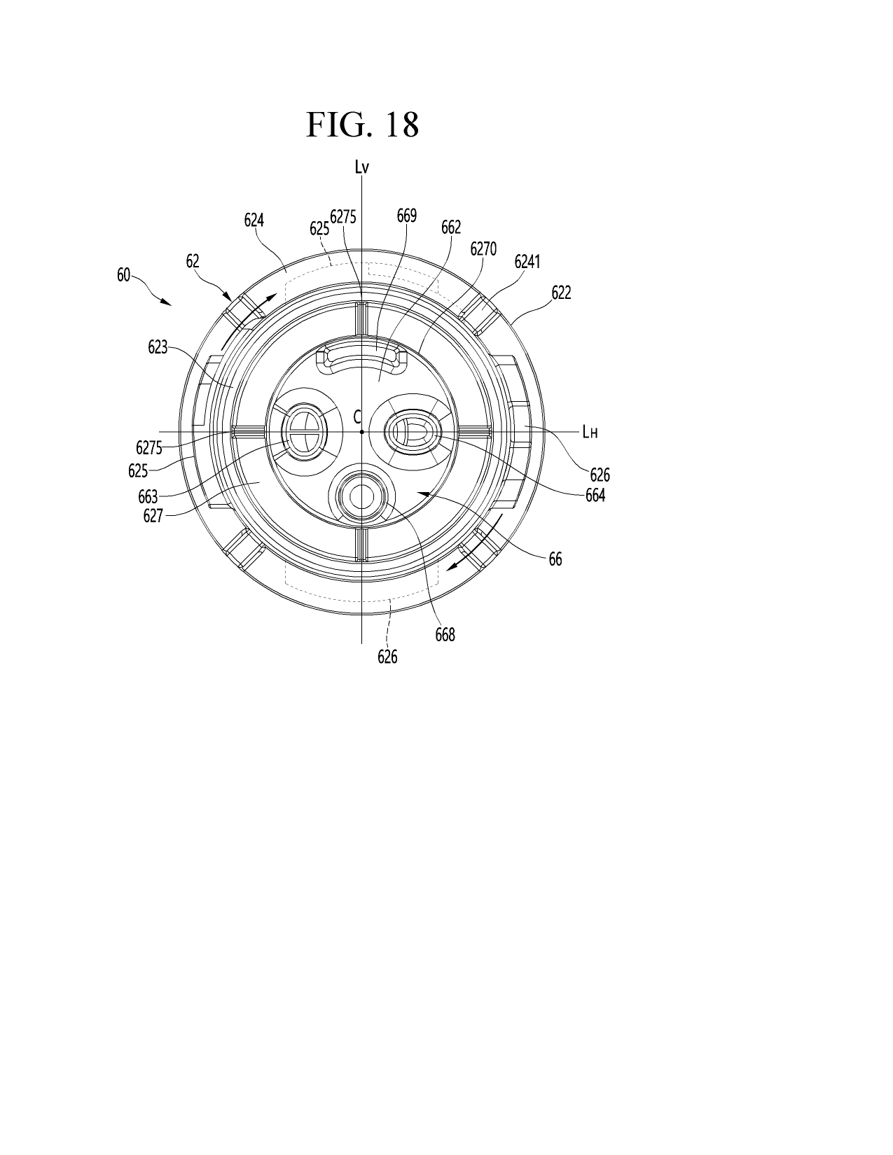

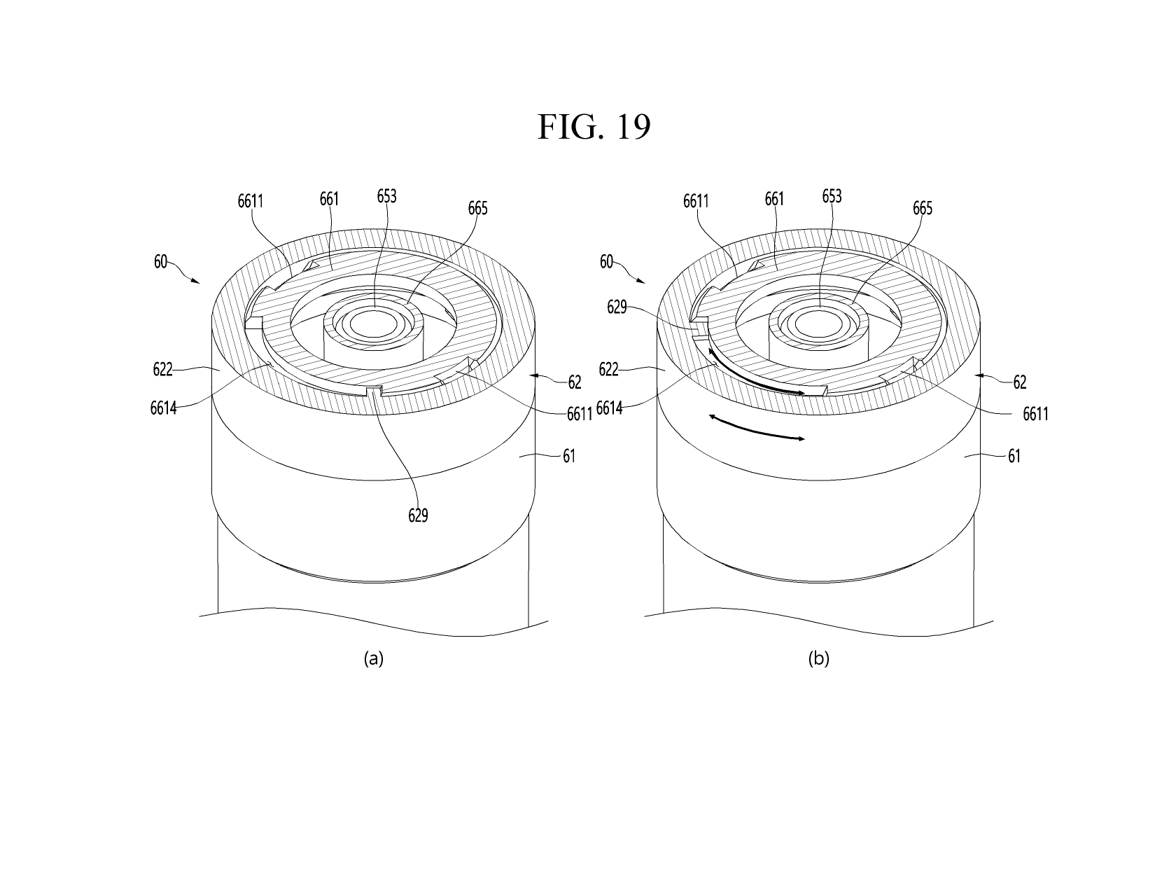

FIG. 18 is a top plan view of the filter showing a rotational state of the housing, and FIG. 19 is a view illustrating the state of the fixing protrusion and the fixing groove according to rotation of the housing.

As illustrated, the alignment state of the water inlet part 663 and the water outlet part 664 can be checked by visually inspecting the upper surface of the filter 60. If the water inlet part 663 and the water outlet part 664 are misaligned, the filter 60 may either not be mountable or be improperly mounted. Accordingly, a user can visually confirm the state of the upper surface of the filter 60 and then align the water inlet part 663 and the water outlet part 664.

Specifically, when the water inlet part 663 and the water outlet part 664 are in a normally aligned state before coupling the filter 60, they are positioned between the first guide protrusion 625 and the second guide protrusion 626, and can be located on the same horizontal extension line LH passing through the center C of the filter 60. In particular, the water inlet part 663 and the water outlet part 664 are arranged on the same extension line as the alignment portions 6275 located on the left and right sides of the filter, thereby allowing the alignment state of the water inlet part 663 and the water outlet part 664 to be accurately visualized by the user. In addition, the user can more precisely confirm the alignment state of the water inlet part 663 and the water outlet part 664 by checking that the minor axis S of the water inlet part 663 and the major axis L of the water outlet part 664 are positioned on the same extension line as the alignment portions.

Meanwhile, as illustrated in FIG. 19 (a) when the water inlet part 663 and the water outlet part 664 are in a properly aligned state before the filter 60 is mounted, the restricting protrusion 629 may come into contact with one end of the restricting groove 6614. In other words, when the housing 600 is completely rotated in a counterclockwise direction so that the restricting protrusion 629 and the restricting groove 6614 are in contact with each other and rotation is prevented, the water inlet part 663 and the water outlet part 664 may be in the proper alignment state.

In the process of mounting the filter 60 to the head 50, the filter cover 66 — that is, the water inlet part 663 and the water outlet part 664 — may remain in a stationary state, while the housing 600 may be rotated clockwise relative to the filter cover 66.

When the mounting of the filter 60 to the head 50 is completed, the housing 600 may be rotated by a set angle (approximately 90°) clockwise relative to the filter cover 66. At this time, the first guide protrusion 625 and the second guide protrusion 626 may be arranged in a direction intersecting the arrangement direction of the water inlet part 663 and the water outlet part 664. And, the first guide protrusion 625 and the second guide protrusion 626 may be disposed on the same extension line as the vertical extension line LV passing through the center C of the filter cover 66.

As illustrated in FIG. 19 (a), when the rotation of the housing 600 is completed and the filter 60 is mounted to the head 50, the restricting protrusion 629 may come into contact with the opposite end of the restricting groove 6614. In other words, the housing 600 may be fully rotated in the clockwise direction and reach a state where it can no longer rotate, allowing the user to recognize that the mounting of the filter 60 is complete.

Meanwhile, during the assembly and distribution process of the filter 60 or during repeated attempts to mount the filter, the housing 600 may unintentionally rotate relative to the filter cover 66.

In such a case, the water inlet part 663 and the water outlet part 664 may become misaligned with the alignment portions 6275 located on the left and right sides. The user can visually check this misalignment and then relatively rotate the housing 600 or the filter cover 66 to adjust the positions of the water inlet part 663 and the water outlet part 664 so that they are located on the same extension line as the alignment portions 6275 on the left and right sides. The user may rotate the housing 600 or the filter cover 66 until the restricting protrusion 629 can no longer rotate counterclockwise within the restricting groove 6614, thereby placing the filter 60 into a normal alignment state.

Hereinafter, the mounting process of the filter 60 having the above-described structure will be described in more detail with reference to the drawings.

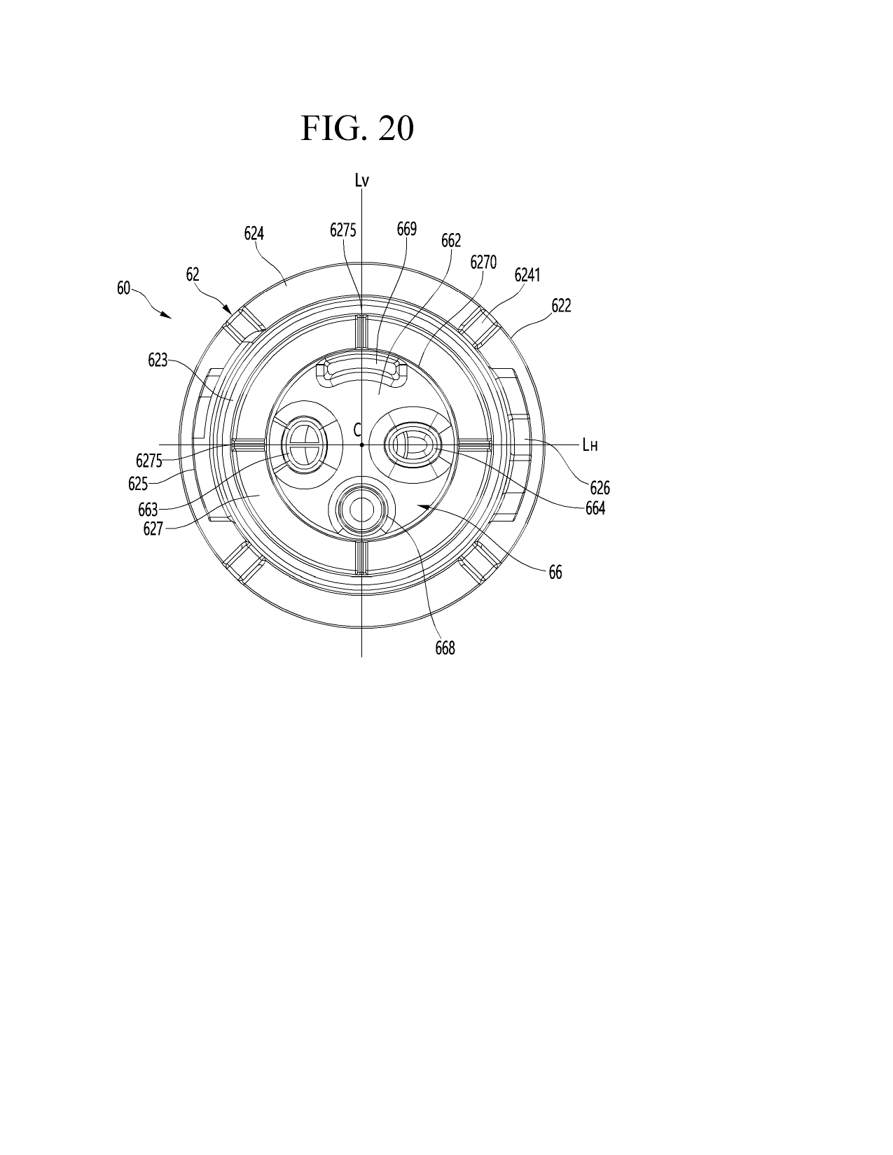

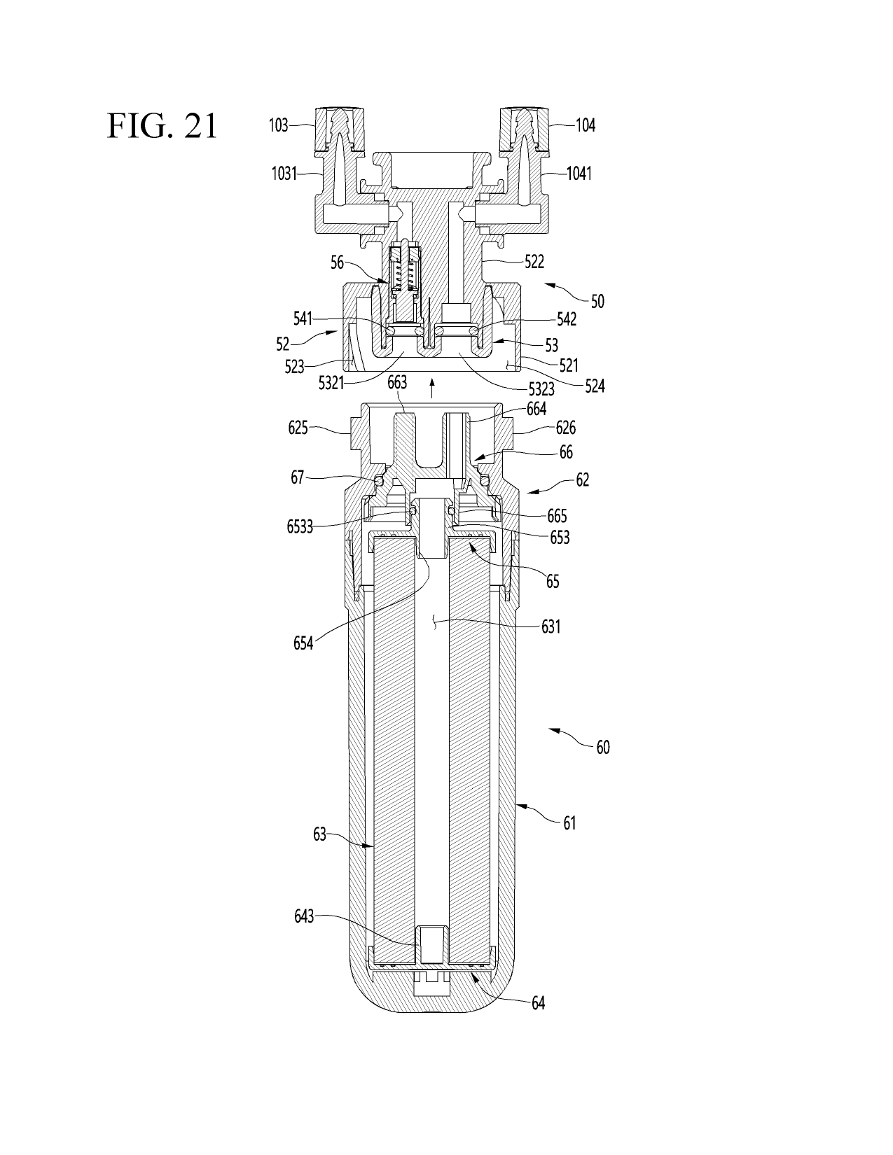

FIG. 20 is a top plan view of the filter before the filter is mounted, and FIG. 21 is a longitudinal sectional view showing a state in which the filter and the head are separated before assembly.

As illustrated, the filter 60 has a structure in which the housing 600 is rotated relative to the filter cover 66 and coupled to the head body 52. Therefore, in order to ensure proper installation of the filter 60, the water inlet part 663 and the water outlet part 664 must remain in a normal alignment state.

As shown in FIG. 20, in the normal alignment state, it can be confirmed that the water inlet part 663 and the water outlet part 664 are positioned approximately between the first guide protrusion 625 and the second guide protrusion 626.

In particular, the water inlet part 663 and the water outlet part 664 can be aligned with the alignment portions 6275 located on the left and right sides of the upper opening 6270. In other words, the alignment portion 6275 can be positioned on the same line as the inlet contact portion 6632 of the water inlet part 663. Therefore, the user can more accurately determine the alignment state of the filter 60 by checking the arrangement of the alignment portion 6275 and the inlet contact portion 6632.

Accordingly, the user can couple the filter 60 after accurately checking the alignment state of the alignment portion 6275 exposed to the upper surface of the filter 60 and the alignment of the water inlet part 663 and the water outlet part 664. If the water inlet part 663 and the water outlet part 664 are not aligned before the filter 60 is mounted to the head 50, the user may relatively rotate the filter cover 66 with respect to the housing 600 to align them as described above.

When the filter 60 is in the aligned state, the first guide protrusion 625 and the second guide protrusion 626 may be located on the left and right sides, respectively. To couple the filter 60 to the head, the user may position the first guide protrusion 625 and the second guide protrusion 626 below the first guide hole 5231 and the second guide hole 5241, respectively, which are opened on the lower surface of the head body 52. At this time, the water inlet part 663 and water outlet part 664 of the filter 60, in their aligned state, may be positioned below the inlet hole 5321 and outlet hole 5323.

In this aligned state, the filter 60 may be moved upward to begin coupling the filter 60 to the head 50.

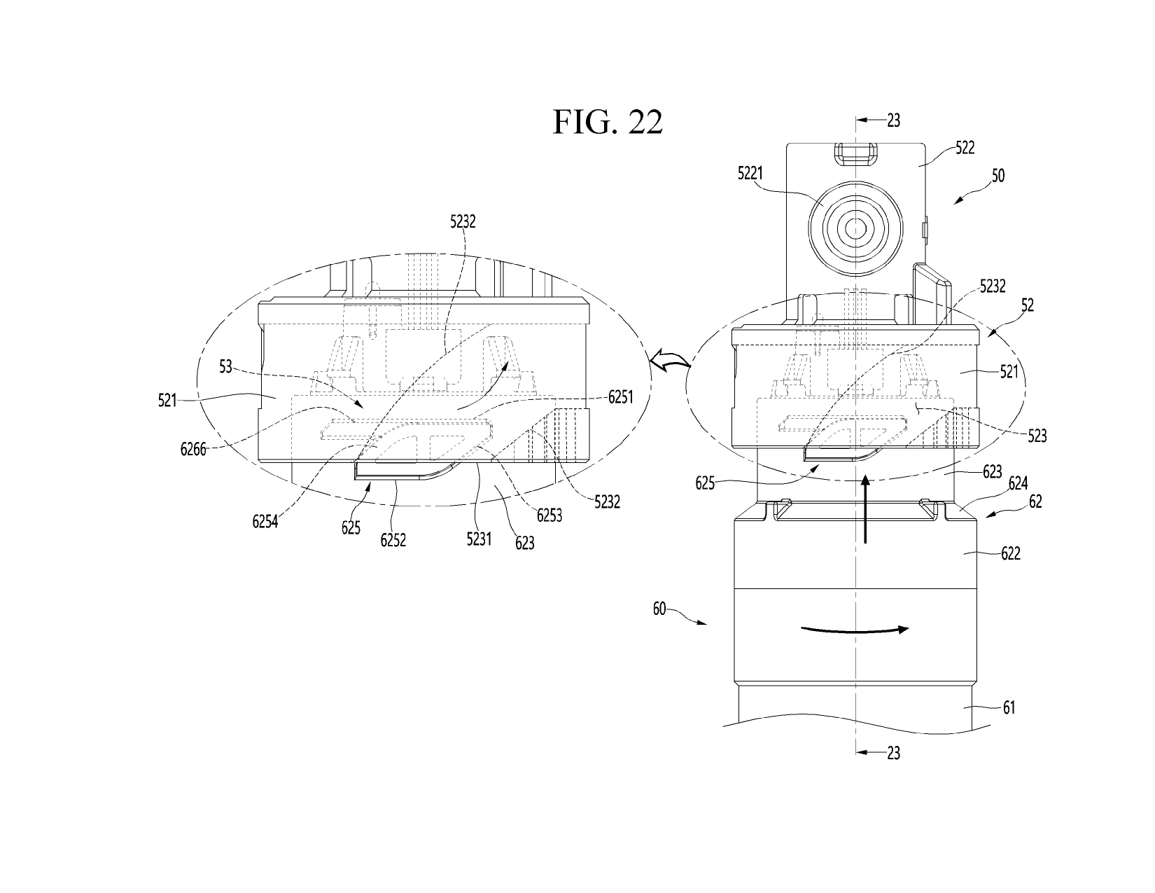

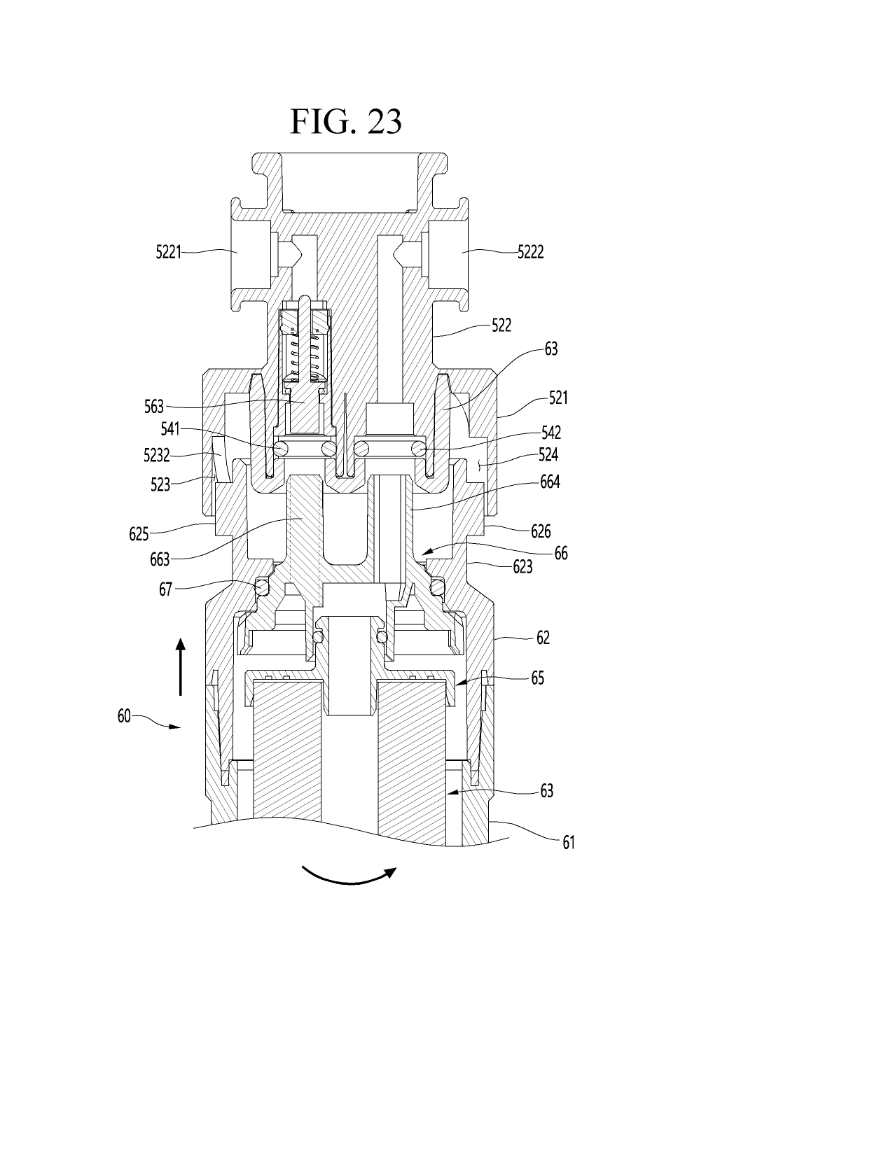

FIG. 22 is a view illustrating a coupling structure of the guide protrusion and the guide part when the filter is coupled to the head, and FIG. 23 is a cross-sectional view taken along line 23-23 of FIG. 22.

As illustrated, the upper end of the filter 60 may be inserted through the open lower surface of the head body 52. When the filter 60 begins to couple with the head body 52, the first guide protrusion 625 may be inserted into the first guide 523, and the second guide protrusion 626 may be inserted into the second guide 524.

In particular, the first guide protrusion 625 may be structurally prevented from being inserted into the second guide 524, thereby preventing incorrect installation of the filter 60. Furthermore, the cross-sections of the water inlet part 663 and water outlet part 664 are formed to have directionality, so that they can only be inserted into the inlet hole 5321 and outlet hole 5323 when the first guide protrusion 625 is inserted into the first guide 523 and the second guide protrusion 626 is inserted into the second guide 524.

The first guide protrusion 625 and the second guide protrusion 626 may move along the inclined surfaces of the first guide portion 5232 and second guide portion 5242 within the first guide 523 and second guide 524. As the first guide protrusion 625 and the second guide protrusion 626 move along the first guide 523 and the second guide 524, the housing 600 may be rotated in a clockwise direction.

Additionally, the water inlet part 663 and water outlet part 664 may be inserted into the corresponding inlet hole 5321 and outlet hole 5323, respectively. The water inlet part 663 and water outlet part 664 may be inserted into the inlet hole 5321 and outlet hole 5323 at the moment when the first guide protrusion 625 and second guide protrusion 626 are inserted into the first guide 523 and second guide 524.

At this point, since the water inlet part 663 and water outlet part 664 are already in an aligned state, proper installation may be achieved simply by inserting the first guide protrusion 625 and the second guide protrusion 626 into the first guide 523 and the second guide 524 without any additional alignment process.

In addition, the fixing protrusion 669 and the sensing member 668 can also be inserted into the inside of the fixing groove 5329 and the sensing hole 5237, respectively. At this time, the fixing protrusion 669 comes into contact with the inner surface of the fixing groove 5329, thereby ensuring stable rotation of the housing 600 while preventing torque generated during the rotation of the housing 600 from being transmitted to the water inlet part 663 and the water outlet part 664.

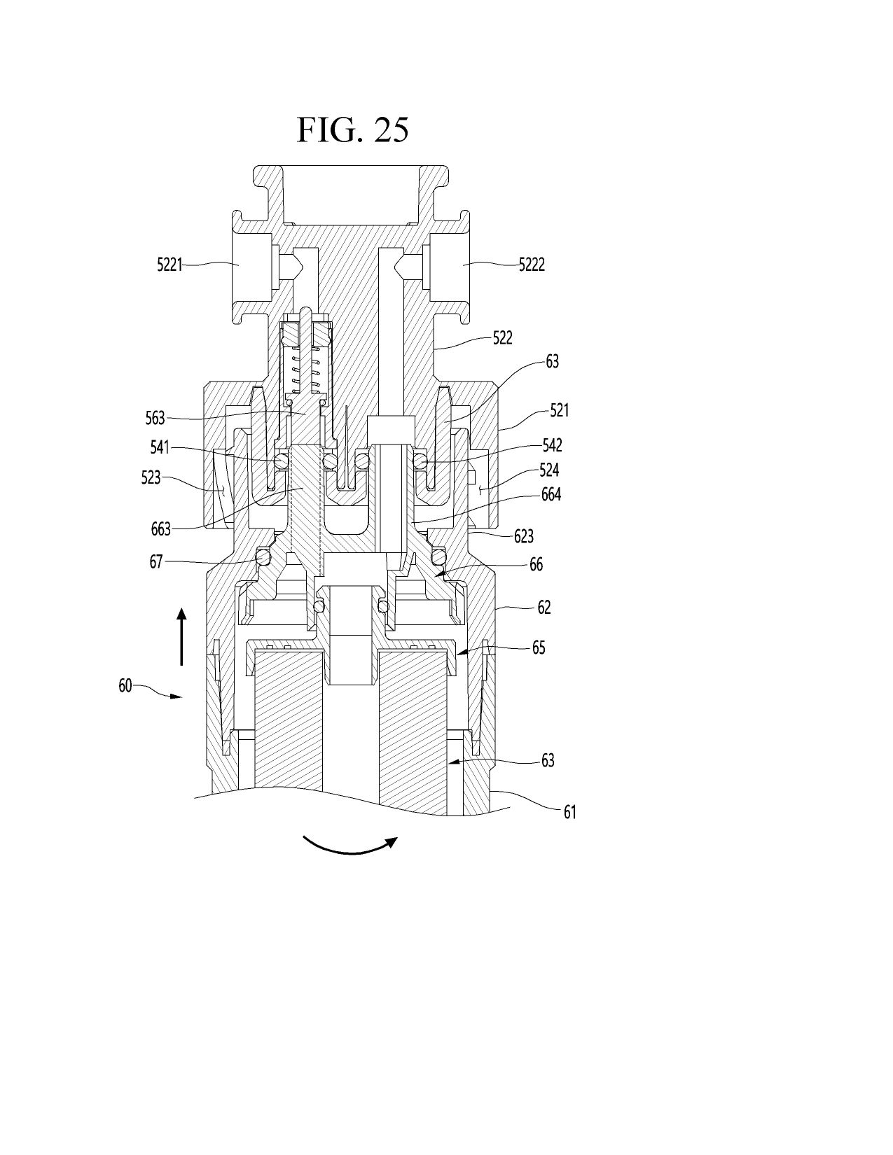

FIG. 24 is a top plan view of the filter while being inserted into the head, and FIG. 25 is a longitudinal sectional view showing the coupling state of the filter and the head as shown in FIG. 24.

As illustrated, the filter 60 may be rotated while inserted into the head 50 to complete coupling with the head 50. In this process, the housing 600 may rotate relative to the filter cover 66 while moving upward, and the filter cover 66 may also move upward while being engaged with the head inner 53.

Specifically, as the housing 600 is rotated, the first guide protrusion 625 and the second guide protrusion 626 may move upward along the first guide 523 and the second guide 524, respectively. The water inlet part 663 and the water outlet part 664 may further move upward while passing through the inlet ring 541 and the outlet ring 542, respectively. Accordingly, the water inlet part 663 and water outlet part 664 may be in a sealed state inside the inlet hole 5321 and the outlet hole 5323.

In this state, the housing 600 can be rotated by a set angle α4. That is, the alignment portion 6275 is positioned at a location rotated clockwise by the set angle α4 with respect to the horizontal extension line LH passing through the water inlet part 663, the water outlet part 664, and the center C of the filter cover 66. At this time, the set angle α4 may be approximately 45°.

And the housing 600 may be further moved upward as the first guide protrusion 625 and the second guide protrusion 626 travel along the first guide 523 and the second guide 524. The water inlet part 663 and the water outlet part 664 may be inserted further such that the end of the water inlet part 663 comes into contact with the valve 56, thereby starting to open the valve 56.

In addition, the fixing protrusion 669 and the sensing member 668 may be further inserted into the inside of the fixing groove 5329 and the sensing hole 5237, respectively. When the sensing member 668 is completely inserted into the sensing hole 5237, the filter sensing device 55 can detect this and open the water supply valve 102, thereby initiating water supply toward the filter 60.

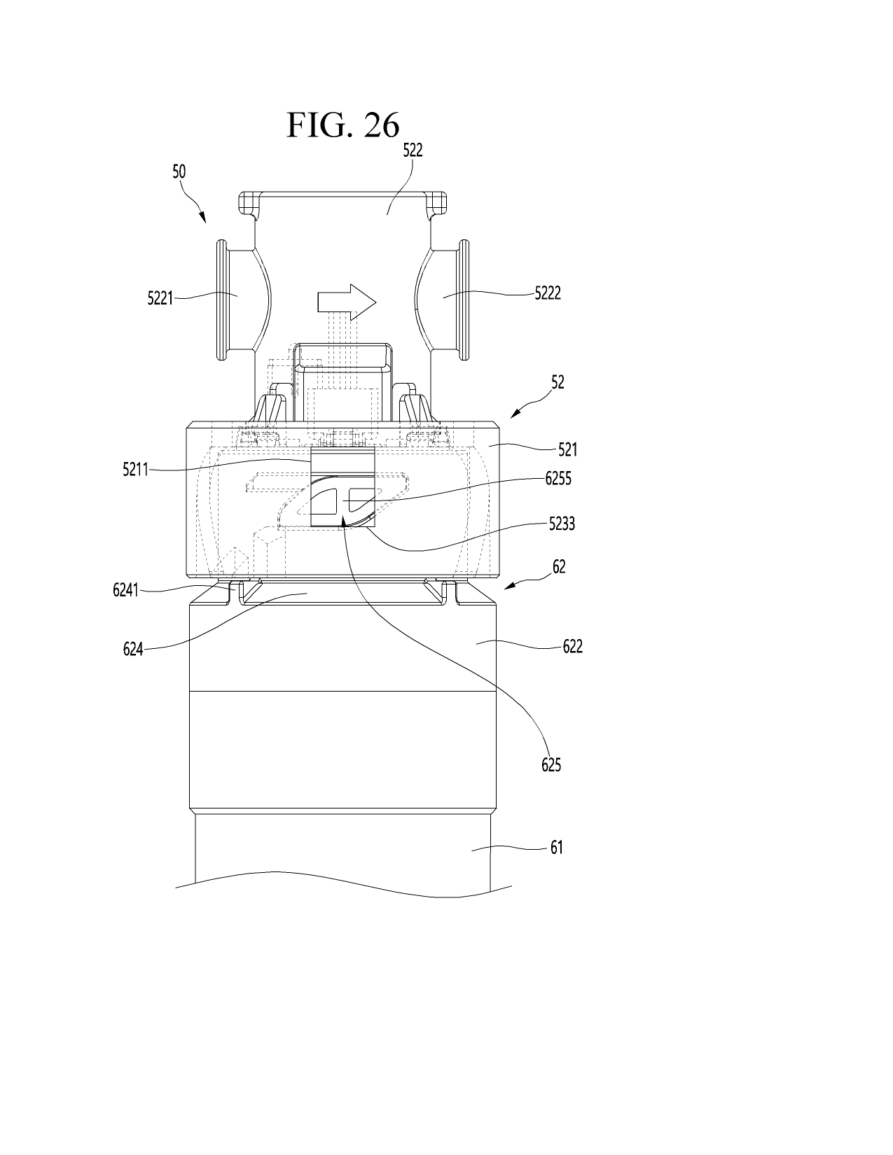

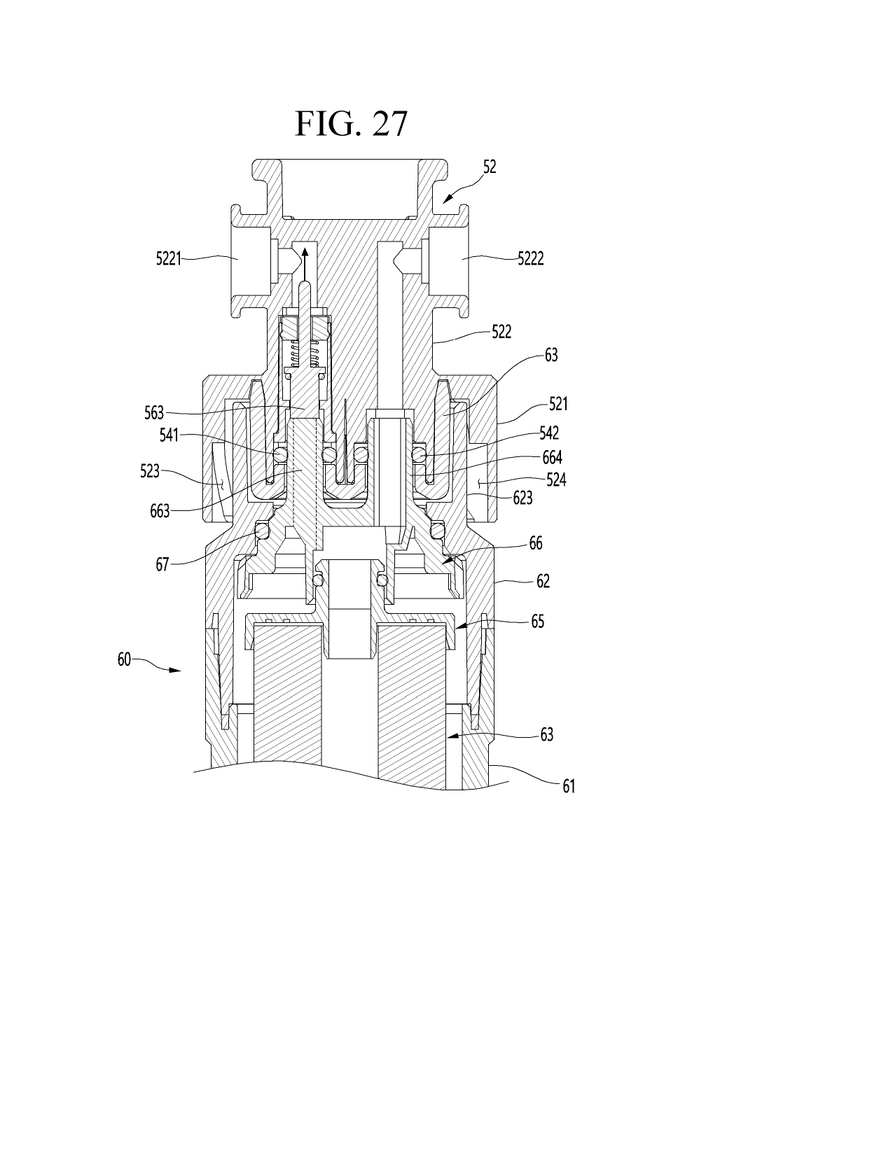

FIG. 26 is a front view showing a state in which the filter and the head are completely coupled, and FIG. 27 is a top plan view of the filter when the filter and the head are completely coupled.

As illustrated, when the filter 60 is fully coupled to the head body 52, the first guide protrusion 625 and the second guide protrusion 626 may move laterally at the upper ends of the first guide 523 and the second guide 524 and remain in a fixed state.

At this time, the first guide protrusion 625 may be positioned within the check window 5211. The check window 5211 may be opened toward the front, and the first guide protrusion 625 may be exposed forward through the check window 5211. Accordingly, a user may visually confirm that the connecting rib 6255 is positioned at the center of the check window 5211, thereby confirming that the filter 60 has been completely mounted to the head 50.

In detail, at the moment when the filter 60 is completely coupled to the head body 52, the restricting groove 6266 may be latched with the restriction portion 5213 formed on the head 50. The user may determine that the filter 60 has been properly coupled to the head 50 by recognizing the clicking sound or vibration generated at this time.

In addition, as illustrated in FIG. 19 (a), in the state where the filter 60 is completely mounted, the restricting protrusion 629 may come into contact with the other end of the restricting groove 6614. Accordingly, when the user rotates the housing 600 in the clockwise direction during the rotational operation until the housing 600 can no longer rotate, the user may determine that the filter 60 has been completely mounted to the head 50.

And, when the water inlet part 663 and the water outlet part 664 are completely inserted into the inlet hole 5321 and the outlet hole 5323, respectively, the inside of the filter 60 may be in fluid communication with the inlet flow path 5241 and the outlet flow path 5251 of the head 50. When the installation of the filter 60 is completed, the valve 56 and the water supply valve 102 may be opened, allowing water to be supplied to the filter 60 for purification.

Hereinafter, the water flow state of the filter assembly 40 with the filter 60 coupled will be described in greater detail with reference to the drawings.

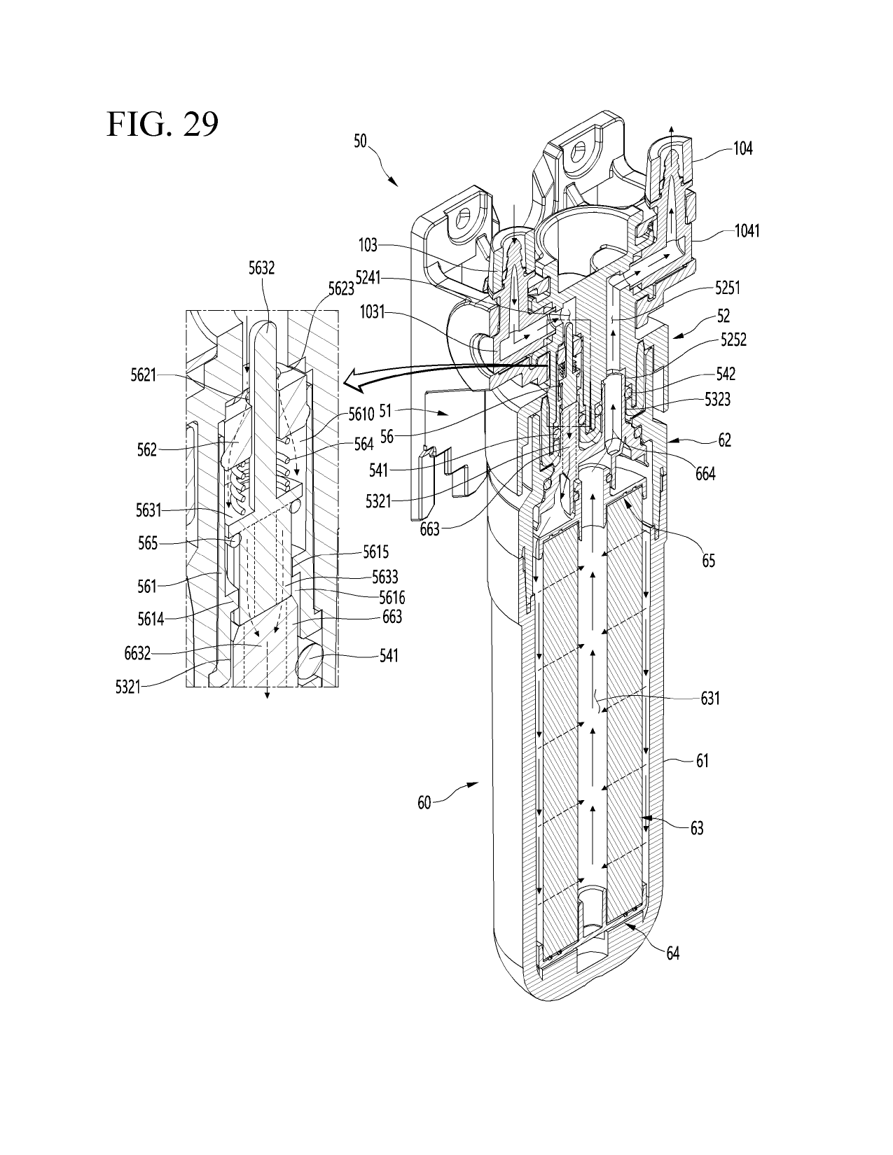

FIG. 29 is a view illustrating water flow when the filter is completely coupled to the head.

As illustrated, when the filter 60 is fully coupled to the head 50, the water inlet 663 and the water outlet 664 may be inserted into the inlet hole 5321 and outlet hole 5323, respectively.

The upper end of the water inlet part 663 may then come into contact with the contact portion 5633, thereby pushing the piston 563 upward to open the case passage 5615. With the water supply valve 102 open, water supplied through the inlet passage 5241 may flow through the cap through-hole 5623 and into the piston accommodating portion 5610.

When the piston 563 is moved upward, water may flow through the flow path space S, pass through the case passage 5615, and flow into the inlet accommodating portion 5616. The water introduced into the inlet accommodating portion 5616 may then be supplied to the inside of the filter 60 through the inlet flow path 6631 of the inlet 663 inserted into the inlet accommodating portion 5616.

Accordingly, water introduced through the inlet pipe 103 may flow through the inlet passage 5241 of the head 50, the valve 56, and the inlet flow path 6631, and be introduced into the interior of the filter 60. The introduced flow may be guided to the outer side of the filter member 63 through the first space 6610. Water on the outer side of the filter member 63 may pass through the filter member 63 and move into the hollow portion 631. During this process, the water may be purified. The purified water may flow upward through the hollow portion 631 toward the second space 6651 and may be discharged through the outlet 664.

Then, the purified water of the filter 60 may flow through the outlet 664 into the outlet passage 5251 and be discharged to the outside through the outlet pipe 104.

While water flows through the filter 60, the peripheries of the water inlet part 663 and water outlet part 664 may be sealed by the inlet ring 541 and the outlet ring 542, respectively, thereby preventing leakage.

The filter 60 may be detached from the head 50 after purifying water for a predetermined period or a preset amount of water and then replaced with a new filter 60. In order to detach the filter 60 from the head 50, the housing 600 is rotated and moved downward in the reverse order of the process described above. During this reverse rotation of the filter 60, the water inlet part 663 and water outlet part 664 move downward and are disengaged from the inlet hole 5321 and the outlet hole 5323. Then, the valve 56 is closed again by the downward movement and separation of the water inlet part 663, thereby preventing water introduced through the inlet pipe 103 from leaking to the outside of the head 50.

Meanwhile, in addition to the embodiment described above, various other embodiments of the present invention are also possible. Hereinafter, another embodiment of the present invention will be described with reference to the drawings. For the components of the other embodiment that are identical to those of the previous embodiment, detailed descriptions and illustrations may be omitted, and the same reference numerals may be used for explanation.

That is, only the structures different from those of the previous embodiment will be described hereinafter, and the other components that are not described may be the same as those of the previous embodiment. Accordingly, components that are not illustrated or not described in detail may be referred to in the drawings of the previous embodiments.

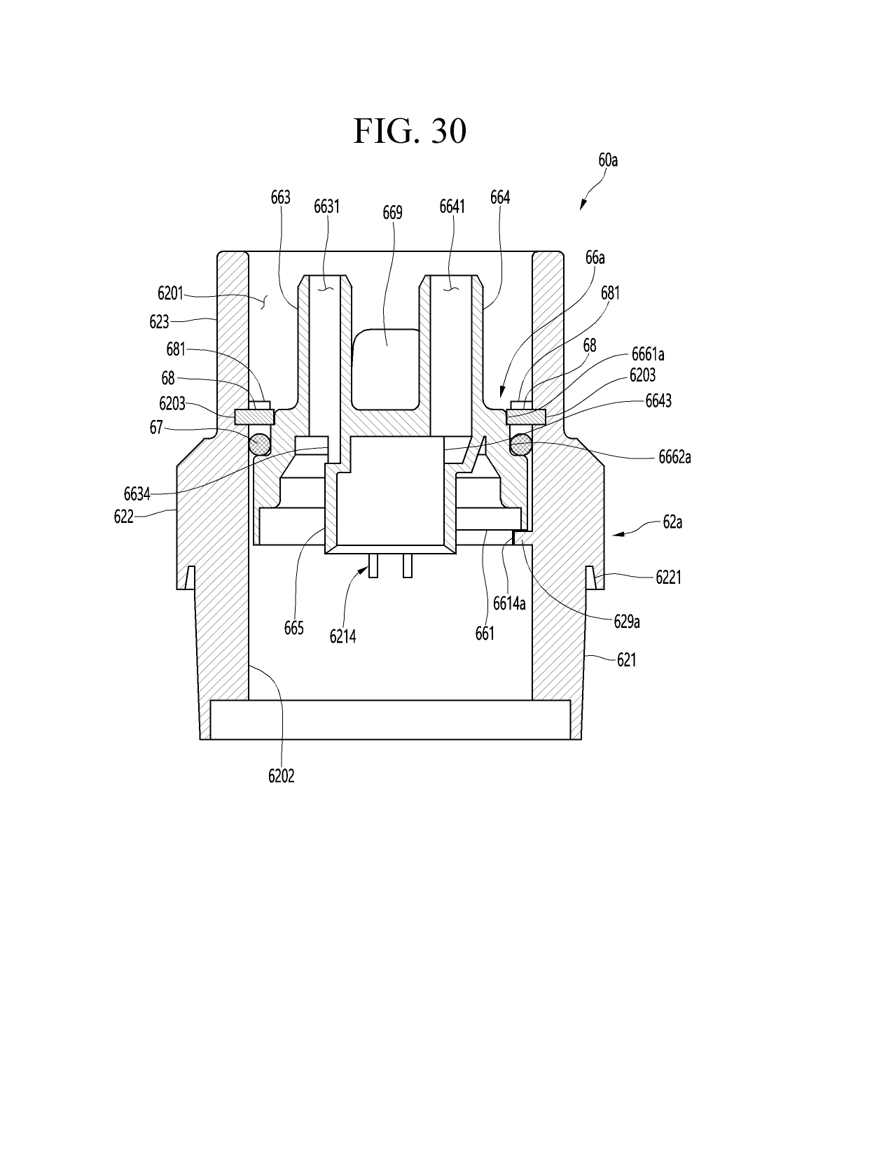

FIG. 30 is a longitudinal sectional view showing a coupling state of the housing and the filter cover according to the second embodiment of the present disclosure.

As illustrated, the filter 60a according to the second embodiment of the present disclosure may include a housing 600 and a filter cover 66a.

The filter cover 66a may be inserted through the open upper surface of the housing 600 and may shield the open upper surface of the housing 600. Compared to the previously described embodiment, only the inner structure of the upper portion of the housing 600 and the peripheral shape of the filter cover 66a differ, while the other components may be formed identically to those in the previously described embodiment.

Specifically, the filter 60a may be detachably provided to the head 50. The filter 60a may include an upper housing 62a. The upper housing 62a may include an upper part 623 inserted into the head 50, a lower part 623 coupled to the lower housing 61, and a housing coupling part 621. The upper housing 62a may have an open top and bottom and may be formed with a hollow portion 6201 penetrating in the vertical direction. The inner surface 6202 of the upper housing 62a may be formed to have the same diameter from the top to the bottom.

In addition, support protrusions 6214 for supporting the filter cover 66a may be formed on the inner surface 6202 of the upper housing 62a. A plurality of the support protrusions 6214 may be provided, and they may support the lower end of the filter cover 66a.

In addition, a fixing groove 6203 in which the restraining member 68 is secured may be formed on the inner surface 6202 of the upper housing 62a. The fixing groove 6203 may be recessed outward at a position corresponding to the restraining member 68 and may be formed along the inner surface 6202. The fixing groove 6203 may be formed above the support protrusion 6211 and positioned higher than the sealing member 67 described below. Furthermore, the fixing groove 6203 may be formed at a height corresponding to the second stepped portion 6661a described below.

Additionally, a restricting protrusion 629a may be formed on the inner surface of the upper housing 62a. The restricting protrusion 629a may protrude inward toward the center of the upper housing 62a. The restricting protrusion 629a may be inserted into a restricting groove 6614a recessed along the circumference of the filter cover 66a.

The restricting protrusion 629a may be positioned above the support protrusions 6213, 6214. Accordingly, when the filter cover 66a is supported by the support protrusions 6213, 6214, the restricting protrusion 629a may be inserted into the restricting groove 6614a, allowing the housing 600 to rotate within a predetermined angle.

The filter cover 66a may include a cover rim 661 forming its circumference and stepped portions 6661a, 6662a having a smaller diameter than the cover rim 661 and formed on the upper surface of the cover rim 661.

The cover rim 661 may be adjacent to the inner surface 6202 of the upper housing 62a. Further, the lower end of the cover rim 661 may be supported by the support protrusions 6213, 6214.

In addition, a restricting groove 6614a, which is recessed along the circumference of the filter cover 66a, may be formed on the circumference of the cover rim 661. The restricting groove 6614a may be opened downward and laterally. Accordingly, when the filter cover 66a is inserted downward through the open upper surface of the housing 600, the restricting protrusion 629a may be inserted.

The restricting groove 6614a may receive the restricting protrusion 629a, allowing the housing 600 to rotate within a predetermined angle. Before the filter 60a is mounted to the head 50, the restricting protrusion 629a may be positioned at one end of the restricting groove 6614a. When the filter 60a is completely mounted to the head 50, the restricting protrusion 629a may be positioned at the other end of the restricting groove 6614a. By the restricting groove 6614a and the restricting protrusion 629a, the housing 600 may be rotated by the predetermined angle. For example, the predetermined angle may be 90°.

The stepped portions 6661a, 6662a may be formed in multiple steps, including a first stepped portion 6661a formed at the upper side and a second stepped portion 6662a formed at the lower side. The second stepped portion 6662a may protrude farther outward than the first stepped portion 6661a. In addition, the cover rim 661 may protrude farther outward than the second stepped portion 6662a.

A sealing member 67 may be seated on the first stepped portion 6661a to hermetically seal the space between the housing 600 and the filter cover 66a. The second stepped portion 6662a may be located below the first stepped portion 6661a and may provide a surface on which a restraining member 68 is seated.

The restraining member 68 may be formed in a disc or ring shape, and its circumference may be inserted into the fixing groove 6203. The restraining member 68 may be press-fitted into the fixing groove 6203 by elastic deformation. For example, the restraining member 68 may be formed in a ring shape with a partial cut so that, when it is inserted into the fixing groove 6203, it elastically deforms to fit into the fixing groove 6203 and presses the second stepped portion 6662a to secure the filter cover 66a from above.

The filter cover 66a may be inserted through the open upper surface of the upper housing 62a, and the lower end of the cover rim 661 may be supported by the support protrusions 6213 and 6214. By inserting the filter cover 66a, the restricting protrusion 629a may be inserted into the interior of the restricting groove 6614a.

In the state where the filter cover 66a is inserted, the sealing member 67 may be seated on the first stepped portion 6661a to hermetically seal the space between the filter cover 66a and the upper housing 62a.

Then, the restraining member 68 may be inserted through the open upper surface of the upper housing 62a. At this time, the circumference of the restraining member 68 may be inserted into the fixing groove 6203, and the lower surface of the restraining member 68 may be supported on the upper surface of the second stepped portion 6661a.

Accordingly, the filter cover 66a may be restrained by the restraining member 68 so as not to be separated upward. In addition, the restraining member 68 may shield the sealing member 67 from above, thereby preventing the sealing member 67 from being separated or dislodged.

The upper housing 62a may be relatively rotatable by a predetermined angle with respect to the filter cover 66a through the restricting protrusion 629a and the restricting groove 6614a, and the space between the upper housing 62a and the filter cover 66a may be hermetically sealed.

Meanwhile, a water inlet part 663 and a water outlet part 664 may protrude upward from the upper surface of the filter cover 66a.

The water inlet part 663 and the water outlet part 664 may respectively have a water inlet flow path 6631 and a water outlet flow path 6641 formed therein for water flow. Further, a fixing protrusion 669 may be formed on the inner upper surface 662. In addition, a sensing member 668 may also be formed on the inner upper surface 662.

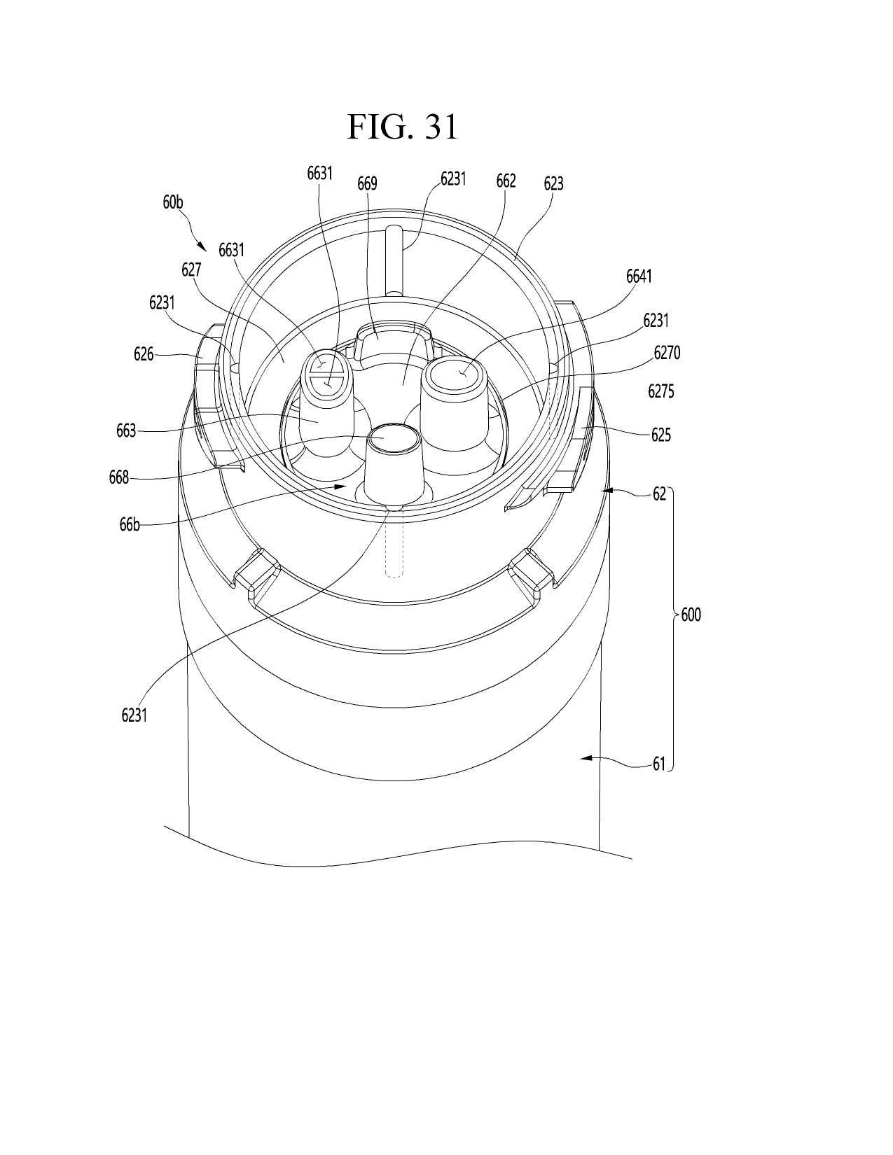

FIG. 31 is a partial perspective view of the filter as seen from above according to the third embodiment of the present disclosure.

As illustrated, the filter 60b according to the third embodiment may be configured to be detachably mounted to the head 50. Compared with the first embodiment described above, only the upper shape of the upper housing 62b is different, and the remaining configuration may be the same.

The outer appearance of the filter 60b may be formed by the housing 600, which may be formed by the coupling of the lower housing 61 and the upper housing 62b. The upper housing 62b may be provided with the filter cover 66. The filter cover 66 may shield the upper opening 6270 of the upper housing 62b, and its upper surface may be exposed through the upper opening 6270. Further, a water inlet part 663 and a water outlet part 664 may be formed on the upper surface of the filter cover 66.

The water inlet part 663 and the water outlet part 664 may have an elliptical cross-sectional shape. Further, the water inlet part 663 and the water outlet part 664 may be arranged such that their major axes face different directions.

On the upper surface of the filter cover 66, a sensing member 668 and a fixing protrusion 338 may be formed to protrude. The sensing member 668 and the fixing protrusion 338 may be provided between the water inlet part 663 and the water outlet part 664. The sensing member 668 may be disposed at the front side with respect to the center of the filter cover 66, and the fixing protrusion 338 may be disposed at the rear side with respect to the center of the filter cover 66. Accordingly, an extension line connecting the water inlet part 663 and the water outlet part 664 may intersect with an extension line connecting the sensing member 668 and the fixing protrusion 338.

Further, the upper housing 62b may include an upper part 623 that extends upward. The upper part 623 may extend further upward than the top of the filter cover 66, that is, further upward than the top of the water inlet part 663 and the water outlet part 664.

In addition, the upper part 623 may extend upward along the circumference of the upper housing 62. In this case, a pair of upper parts 623 may be provided on the left and right sides of the upper housing 62. The upper part 623 may be provided with a first guide protrusion 625 and a second guide protrusion 626 for coupling the filter 60b with the head 50.

An alignment portion 6231 for checking the alignment state of the filter 60b may be formed on the inner surface of the upper housing 62. The alignment portion 6231 may be exposed through the open upper surface of the upper housing 62.

Specifically, the alignment portion 6231 may be formed on the inner surface of the upper part 623. The alignment portion 6231 may be located between the upper surface of the first protrusion 627, where the upper opening 6270 is formed, and the upper end of the upper part 623.

The alignment portion 6231 may be formed on the left and right sides with respect to the center of the filter cover 66. The alignment portion 6231 may be positioned on the same extension line as the water inlet part 663 and the water outlet part 664. Additionally, the alignment portion 6231 may be further formed on the front and rear sides with respect to the filter cover 66 and positioned on the same extension line as the detection member 339 and the fixing protrusion 338.

Accordingly, before mounting the filter 60b, the user can confirm the alignment state of the filter 60b by checking that the alignment portion 6231 and the water inlet part 663 and the water outlet part 664 are positioned on the same extension line as the alignment portion 6231.

Once the filter 60b is confirmed to be in a proper alignment state, it can be mounted to the head 50 so that the water inlet part 663 and the water outlet part 664 communicate with the flow paths inside the head 50.

According to an embodiment of the present disclosure, the water filter and the home appliance equipped with the water filter have the following advantageous effects.

When the filter is mounted, the rotation angle of the housing can be determined by the restricting protrusion and the restricting groove. In particular, the water inlet part and the water outlet part can be aligned when the restricting protrusion comes into contact with the end of the restricting groove. Accordingly, before the filter is mounted, the water inlet part and the water outlet part can be aligned to prevent incorrect installation of the filter and to ensure proper mounting.

In addition, since the rotation angle of the housing is determined by the restricting protrusion and the restricting groove, accurate coupling of the filter can be guaranteed.

Furthermore, the housing may be provided with an alignment portion that allows a user to visually confirm whether the water inlet part and the water outlet part are in a properly aligned state. Therefore, during installation of the filter, the alignment state of the water inlet part and the water outlet part can be easily confirmed.

If the water inlet part and the water outlet part are not in an aligned state, the filter cover can be rotated so that they are aligned with the alignment portion.

What is claimed is:

1. A water filter detachably coupled to a head connected to a water supply source comprising:
a housing having an upper opening opened upward and coupled to the head by rotation;
a filter cover provided inside the housing, configured to cover the upper opening, and including a water inlet part for water inflow and a water outlet part for water outflow; and
a filter member connected to the filter cover inside the housing for water purification,
wherein a restricting protrusion protrudes from an inner surface of the housing,
a restricting groove into which the restricting protrusion is inserted is formed along a circumference of the filter cover,
the housing is rotated relative to the stationary filter cover, and
a rotation angle of the housing is restricted by the restricting protrusion and the restricting groove.

2. The water filter of claim 1,
wherein the housing includes a protrusion protruding toward a center of the housing to form the upper opening, and
a circumference of the filter cover is restrained from upward movement by the protrusion.

3. The water filter of claim 2,
wherein the restricting protrusion protrudes downward from a lower portion of the protrusion.

4. The water filter of claim 3,
further comprising a sealing member that seals between the protrusion and the filter cover,
wherein the restricting protrusion is provided below the sealing member.

5. The water filter of claim 3,
wherein the protrusion comprises:
a first protrusion protruding toward the center of the housing and forming the upper opening; and
a second protrusion formed in a stepped below the first protrusion and located farther away from the center of the housing than the first protrusion,
wherein the restricting protrusion protrudes downward from the second protrusion.

6. The water filter of claim 2,
wherein the filter cover is inserted and mounted through an opened lower surface of the housing,
a support protrusion protruding inward is formed on an inner surface of the housing to support a lower end of the filter cover, and
a rim groove recessed upward is formed along the circumference of the filter cover so that the support protrusion passes therethrough.

7. The water filter of claim 6,
wherein the restricting protrusion is positioned above the support protrusion, and
when the support protrusion passes through the rim groove, the restricting protrusion is inserted into the restricting groove.

8. The water filter of claim 7,
wherein the support protrusions are disposed on left and right sides with respect to a center of the housing,
and the restricting protrusion is formed at a position rotated by a first set angle with respect to an extension line (LH) passing through the support protrusions and the center of the housing.

9. The water filter of claim 8,
wherein both ends of the restricting groove are formed at positions rotated by a third set angle with respect to a vertical extension line (LV) passing through the center of the filter cover and the rim groove,
and the first set angle and the third set angle are identical.

10. The water filter of claim 1,
wherein both ends of the restricting groove are spaced apart by an angle of 90° with respect to the center of the filter cover,
and the restricting protrusion comes into contact with each end of the restricting groove at a start and an end of the rotation of the housing.

11. The water filter of claim 1,
wherein the filter cover comprises:
a cover upper surface exposed through the upper opening, on which the water inlet part and the water outlet part are formed;
a cover rim extending downward along a circumference of the cover upper surface; and
a stepped portion formed along the cover rim with a larger diameter than the cover upper surface,
wherein the restricting groove is formed in the stepped portion.

12. The water filter of claim 11,
wherein a plurality of contact protrusions protruding upward are formed on an upper surface of the cover rim and configured to contact a circumferential surface of the upper opening.

13. A water filter detachably coupled to a head connected to a water supply source comprising:
a housing having an upper opening formed to be opened upward and coupled to the head by rotation;
a filter cover provided in the housing to cover the upper opening and configured to rotate relative to the housing;
a water inlet part protruding upward from the filter cover;
a water outlet part protruding upward from the filter cover; and
a filter member disposed inside the housing and connected to the filter cover for purifying water,
wherein an alignment portion for indicating a rotational alignment state of the filter cover is formed outside the upper opening.

14. The water filter of claim 13,
wherein the water inlet part and the water outlet part are disposed on opposite sides with respect to a center of the filter cover,
when the filter cover is in a normal alignment state, the alignment portion is located on the same extension line as the water inlet part and the water outlet part, and
when the filter cover is not in the normal alignment state, the alignment portion is not located on the same extension line as the water inlet part and the water outlet part.

15. The water filter of claim 13,
wherein the housing has a protruding portion protruding toward a center of the housing to form the upper opening, and
wherein the alignment portion is formed on the protruding portion.

16. The water filter of claim 13,
wherein the housing includes an upper part forming an upper end of the housing and extending to be inserted into the head, and
wherein the alignment portion is formed on an inner surface of the upper part.

17. The water filter of claim 13,
wherein the water inlet part and the water outlet part are positioned on opposite sides with respect to a center of the filter cover,
wherein the alignment portion is formed on both sides of the water inlet part and the water outlet part, respectively, and
when the filter cover is in the normal alignment state, the water inlet part and the water outlet part are aligned between the pair of alignment portions.

18. The water filter of claim 13,
wherein guide protrusions protruding for rotational coupling of the housing are formed on both outer sides of the housing, and
when the filter cover is in the normal alignment state, the alignment portion, the water inlet part, and the water outlet part are positioned on the same extension line as the guide protrusions.

19. A home appliance comprising:
a cabinet;
a head provided in the cabinet and connected to a water supply source; and
a water filter detachably coupled to the head,
wherein the water filter comprises:
a housing having an upper opening formed to be opened upward and coupled to the head by rotation;
a filter cover provided inside the housing to cover the upper opening and including a water inlet part through which water is introduced and a water outlet part through which water is discharged; and
a filter member disposed inside the housing and connected to the filter cover for purifying water,
wherein a restricting protrusion protrudes from an inner surface of the housing,
wherein a restricting groove into which the restricting protrusion is inserted is formed along a circumference of the filter cover,
wherein the housing is rotated relative to the filter cover, and
wherein a rotation angle of the housing is restricted by the restricting protrusion and the restricting groove.

20. The home appliance of claim 19,
wherein the water inlet part and the water outlet part are formed to have an elliptical cross-section when viewed from above, and are oriented and aligned in predetermined directions.
